(19) United States
(12) Patent Application Publication
(10) Pub. No.: US 2023/0081552 A1
(43) Pub. Date: Mar. 16, 2023

(54) UPLINK MULTI-ANTENNA TRANSMISSION IN WIRELESS COMMUNICATION SYSTEM

(71) Applicant: MEDIATEK INC., Hsinchu (TW)

(72) Inventors: Kuan-Hung CHOU, Hsinchu (TW); Chin-Kuo JAO, Hsinchu (TW)

(73) Assignee: MEDIATEK INC., Hsinchu (TW)

(21) Appl. No.: 17/886,974

(22) Filed: Aug. 12, 2022

Related U.S. Application Data
(60) Provisional application No. 63/243,229, filed on Sep. 13, 2021.

(51) Int. Cl. H04L 5/00; H04W 52/42; H04B 7/06

(52) U.S. Cl. CPC H04L 5/0026; H04L 5/0051; H04W 52/42; H04B 7/0691

(57) ABSTRACT

A method for codebook-based uplink transmission is described. A sounding reference signal (SRS) configuration can be received from a base station at a user equipment (UE). The UE has N antenna groups. N is an integer greater than two. The SRS configuration indicates N SRS resources for the N antenna groups, respectively. An SRS transmission can be performed using the N SRS resources from the N antenna groups, respectively. A downlink control information (DCI) can be received from the base station. The DCI indicates two SRIs associated with two of the N SRS resources. The DCI indicates two transmission precoder matrix indicators (TPMIs). A PUSCH can be transmitted using two antenna groups of the N antenna groups corresponding to the two SRIs indicated in the DCI and two precoders corresponding to the two TPMIs indicated in the DCI.

### INCORPORATION BY REFERENCE

This present application claims the benefit of U.S. Provisional Application No. 63/243,229, “Methods and Apparatus for Measurement and Transmission in Communication Systems” filed on Sep. 13, 2021, which is incorporated herein by reference in its entirety.

### TECHNICAL FIELD

The present disclosure relates to wireless communications and specifically relates to multi-antenna transmission operations at the network and mobile device in a wireless communication system.

### BACKGROUND

A large number of steerable antenna elements can be employed for transmission and reception at the network side or the device side. At higher frequency bands, the large number of antenna elements can be used for beamforming to extend coverage. At lower frequency bands, the large number of antenna elements can be used to separate users spatially to increase transmission capacity of the spectrum. Channel state information (CSI) for operation of the massive multi-antenna schemes can be obtained by feedback of CSI report based on transmission of reference signals in the downlink or uplink between the network and the mobile device.

### SUMMARY

Aspects of the disclosure provide a method for codebook-based uplink transmission. A sounding reference signal (SRS) configuration can be received from a base station at a user equipment (UE). The UE has N antenna groups. N is an integer greater than two. The SRS configuration indicates N SRS resources for the N antenna groups, respectively. The N SRS resources each are associated with an SRS resource indicator (SRI). An SRS transmission can be performed using the N SRS resources from the N antenna groups, respectively. A downlink control information (DCI) can be received from the base station. The DCI corresponds to a physical uplink shared channel (PUSCH). The DCI indicates two SRIs associated with two of the N SRS resources. The DCI indicates two transmission precoder matrix indicators (TPMIs). The PUSCH can be transmitted using two antenna groups of the N antenna groups corresponding to the two SRIs indicated in the DCI and two precoders corresponding to the two TPMIs indicated in the DCI.

In an embodiment, the DCI indicates more than two SRIs associated with more than two of the N SRS resources. The transmitting can include transmitting the PUSCH using the more than two antenna groups of the N antenna groups corresponding to the more than two SRIs indicated in the DCI.

In an embodiment, the DCI further indicates one of co-phasing information of the two antenna groups and amplitude information of the two antenna groups. In an example, the transmitting the PUSCH includes transmitting the PUSCH using the two antenna groups based on uplink transmission timings of the two antenna groups derived from the co-phasing information of the two antenna groups. In an example, the transmitting the PUSCH includes transmitting the PUSCH using the two antenna groups based on frequency-domain phase compensations of the two antenna groups derived from the co-phasing information of the two antenna groups. In an embodiment, the amplitude information of the two antenna groups is indicated by two transmit power control (TPC) commands indicated in the DCI, the two TPC commands corresponding to the two antenna groups, respectively.

In an embodiment, the method further comprises receiving a group-based beam measurement report configuration, transmitting a group-based beam measurement report based on the group-based beam measurement report configuration, the group-based beam measurement report being obtained based on measurement of channel-state-information reference signals (CSI-RS) or synchronization signal blocks (SSBs) transmitted from the base station, at least two transmission and reception points (TRPs) of the base station, or at least two TRPs of the base station and another base station, and receiving two transmission configuration indicator (TCI) states for an uplink transmission of SRS, PUSCH, or physical uplink control channel (PUCCH), the two TCI states indicating two of the CSI-RS or two of the SSBs transmitted from the base station, the at least two TRPs of the base station, or the at last two TRPs of the base station and the other base station. In an embodiment, the group-based beam measurement report includes (i) information of downlink beams corresponding to ones of the CSI-RS transmitted from the base station, and (ii) information of the antenna groups corresponding to the downlink beams.

In an embodiment, the method can further comprises receiving a configuration of three SRS resources for UE antenna panel selection and beam measurement, the three SRS resources corresponding to three antenna groups of the N antenna groups, the three SRS resources being associated with three SRIs, transmitting SRS using the three SRS resources from the three antenna groups, respectively, receiving two TCI states indicating two SRIs of the three SRIs associated with the three SRS resources for an uplink transmission of SRS, PUSCH, or PUCCH.

Aspects of the disclosure provide another method for codebook-based uplink transmission. The method can include receiving an SRS configuration from a base station at a UE, the UE having N antenna groups, N being an integer greater than two, the SRS configuration indicating N SRS resources for the N antenna groups, respectively, the N SRS resources each associated with an SRI; performing SRS transmission using the N SRS resources from the N antenna groups, respectively; receiving a first DCI from the base station, the first DCI scheduling a PUSCH, the first DCI indicating N TPMIs corresponding to the N antenna groups, respectively; selecting two antenna groups from the N antenna groups for transmission of the PUSCH; selecting two TPMIs from the N TPMIs, the selected two TPMIs corresponding to the selected two antenna groups; and transmitting the PUSCH using the selected two antenna groups with two precoders corresponding to the two TPMIs selected from the N TPMIs indicated in the first DCI.

In an embodiment, a PUCCH is transmitted to indicate the selected two antenna groups by indicating two SRIs corresponding to the two selected antenna groups or the selected two TPMIs corresponding to the two selected antenna groups.

In an embodiment, the N antenna groups include three antenna groups. The method further comprises receiving at least one DCI field each indicating two candidate antenna groups among the three antenna groups or co-phasing information and amplitude information of the respective two candidate antenna groups.

In an example, the transmitting includes transmitting the PUSCH using the selected two antenna groups based on uplink transmission timings or frequency-domain phase compensations of the selected two antenna groups derived from the co-phasing information indicated by the at least one DCI field. In an example, the amplitude information of the respective two candidate antenna groups is indicated by two TPC commands indicated in the respective DCI, the two TPC commands corresponding to the two candidate antenna groups, respectively.

Aspects of the disclosure provide a method for non-codebook-based uplink transmission. The method can include receiving an SRS configuration from a base station at a UE, the UE having three antenna groups, the SRS configuration indicating three groups of SRS resources for the three antenna groups, respectively, each SRS resource of the three groups of SRS resources being associated with an SRI; performing SRS transmission using the three groups of SRS resources from the three antenna groups, respectively, each SRS resource of the three groups of SRS resources corresponding to a transmission beam; and receiving a DCI indicating at least two SRIs of the SRIs associated with each SRS resource of the three groups of SRS resources, the DCI scheduling a PUSCH, the at least two SRIs corresponding to at least two antenna groups, respectively; and transmitting the PUSCH using the transmission beams from two of the at least two antenna groups corresponding to the at least two SRIs, the transmission beams corresponding to two of the at least two SRIs.

In an embodiment, the at least two SRIs include three SRIs corresponding to the three antenna groups, respectively. The method can further include selecting two antenna groups from the three antenna groups, the selected two antenna groups corresponding to the two of the at least two antenna groups corresponding to the at least two SRIs; and transmitting a PUCCH to indicate the selected two antenna groups by indicating the two SRN corresponding to the selected two antenna groups.

### BRIEF DESCRIPTION OF THE DRAWINGS

Various embodiments of this disclosure that are proposed as examples will be described in detail with reference to the following figures, wherein like numerals reference like elements, and wherein:

FIGS. 1-3 show examples of mapping CSI-RS ports or SRS ports to physical antennas.

FIG. 4 shows a linear multi-antenna transmission scheme in a transmitter according to embodiments of the disclosure.

FIG. 5 shows an example of analog multi-antenna processing.

FIG. 6 shows an example of hybrid multi-antenna processing according to some embodiments of the disclosure.

FIG. 7 shows an example of available precoder matrices (two codebooks) for a case of two antenna ports according to an embodiment of the disclosure.

FIG. 8 shows two examples (upper part and lower part) of uplink codebook-based transmission according to embodiments of the disclosure.

FIG. 9 shows an example of uplink non-codebook-based transmission according to some embodiments of the disclosure.

FIG. 10 shows an example where selection of UE antenna panels is carried out in a wireless communication system 1000.

FIG. 11 shows an example of the first approach of codebook design and signaling for codebook-based multi-panel uplink transmission.

FIG. 12 shows an example of co-phasing operation at a UE according to embodiments of the disclosure.

FIG. 13 shows an example of the second approach of codebook design and signaling for codebook-based multi-panel uplink transmission.

FIG. 14A shows a stage of UE panel selection.

FIG. 14B shows a stage of CSI acquisition.

FIG. 15A shows a UE panel selection stage.

FIG. 15B shows SRS resource configurations at a stage of CSI acquisition.

FIG. 15C shows options of DCI indication schemes at a stage of DCI indication.

FIG. 16A shows a CST acquisition stage.

FIG. 16B shows SRS resource configurations at the stage of CSI acquisition.

FIG. 16C shows options of DCI indication schemes at a stage of DCI indication.

FIG. 17 shows a codebook-based multi-panel uplink transmission process 1700 according to an embodiment of the disclosure

FIG. 18 shows another codebook-based multi-panel uplink transmission process 1800 according to an embodiment of the disclosure.

FIG. 19 shows a non-codebook-based multi-panel uplink transmission process 1900 according to an embodiment of the disclosure.

FIG. 20 shows an exemplary apparatus 2000 according to embodiments of the disclosure.

### DETAILED DESCRIPTION OF EMBODIMENTS

I. Multi-Antenna Operations

I. Reference Signals and Channel State Information (CSI)

In some embodiments, knowledge of a radio link can be obtained by measurement of reference signals transmitted over the radio link during a channel sounding process. The reference signals in a downlink direction can be referred to as channel-state-information reference signals (CSI-RS). The reference signals in an uplink direction can be referred to as sounding reference signals (SRS).

A CSI-RS can be configured on a per-device basis. A configured CSI-RS may correspond to one or multiple different antenna ports (referred to as CSI-RS ports). Each CSI-RS port can correspond to a channel to be sounded. For example, a multi-port CSI-RS can include 32 per-antenna-port CSI-RS that are orthogonally transmitted on 32 CSI-RS ports. Each per-antenna-port CSI-RS corresponds to a CSI-RS port.

A CSI-RS can be configured for a particular bandwidth (such as a bandwidth part). Within the configured bandwidth, a CSI-RS can be configured for every N resource block. N can be 1, 2, 3, or the like. Within a resource block, a CSI-RS may occupy a set of one or more element resources within a time slot. For a multi-port CSI-RS, the set of element resources are shared by the multiple per-antenna-port CSI-RS, for example, based on a combination of code-domain sharing (CDM), frequency-domain sharing (FDM), or time-domain sharing (TDM).

A device can be configured with one or several CSI-RS resource sets. Each resource set can include one or more configured CSI-RS. Each resource set may also include pointers to a set of New Radio (NR) synchronization signal (SS) blocks. A CSI-RS resource set can be configured for periodic, semi-persistent, or aperiodic transmission. For example, the semi-persistent CSI-RS transmission can be activated or deactivated based on a MAC control element (CE). The aperiodic CSI-RS transmission can be triggered by means of downlink control information (DCI).

Similarly, an SRS can support one or more antenna ports (referred to as SRS ports). Different SRS ports of the SRS can share a same set of resource elements and a same basis SRS sequence. Different rotations can be applied to separate the different SRS ports. Applying a phase rotation (or phase shift) in the frequency domain is equivalent to applying a cyclic shift in the time domain. Similar to CSI-RS, a device can be configured with one or several SRS resource sets. Each resource set can include one or several configured SRS. An SRS resource set can be configured for periodic transmission, semi-persistent transmission (controlled by a MAC CE), or aperiodic transmission (triggered by a DCI).

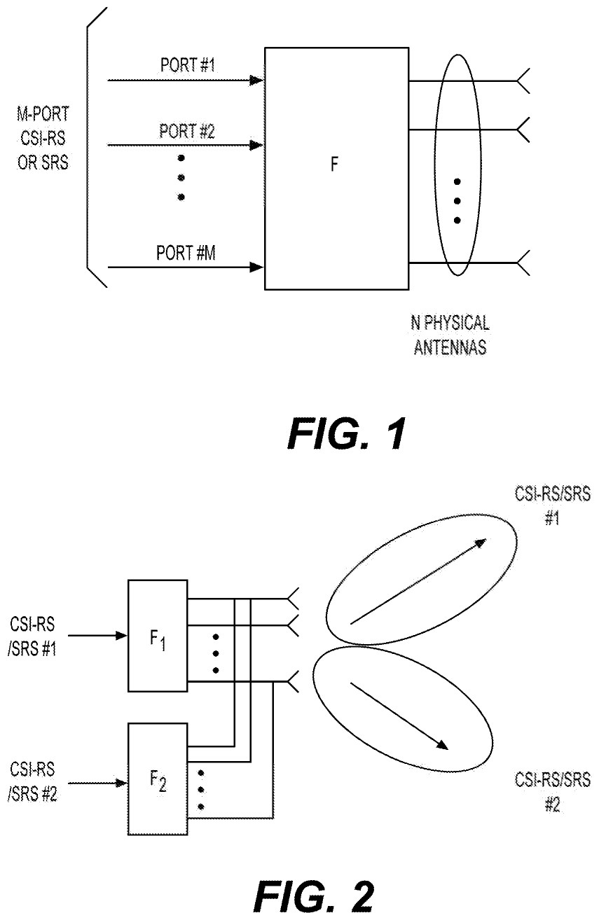

FIGS. 1-3 show examples of mapping CSI-RS ports or SRS ports to physical antennas. In the FIG. 1 example, an M-port CSI-RS or SRS (CSI-RS/SRS) corresponds to M antenna ports (CSI-RS ports or SRS ports). The M antenna ports are connected to N physical antennas through a spatial filter (labeled F). The M-port CSI-RS/SRS are processed by a spatial filter before being mapped to the N physical antennas. Due to the spatial filtering, one or more transmission beams can be formed for transmission of the M-port CSI-RS/SRS. Typically, N can be larger than M.

In the FIG. 2 example, two CSI-RS/SRS #1 and #2 are applied with two separate spatial filters F1 and F2 but transmitted over a same set of physical antennas at a same time or different times. Due to the spatial filtering, the two CSI-RS/SRS #1 and #2 are beamformed in different directions.

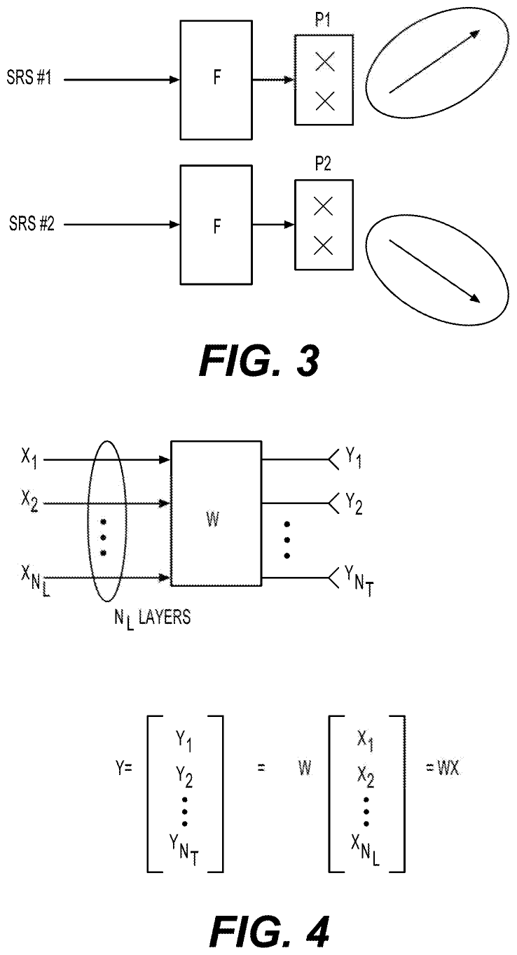

In the FIG. 3 example, multiple antenna panels are employed for transmission. Two CSI-RS/SRS #1 and #2 are processed with two separate spatial filters F1 and F2 and transmitted over two antenna panels P1 and P2, respectively, at a same time or different times. Due to the spatial filtering and the respective antenna panels, the two CSI-RS/SRS #1 and #2 are beamformed in different directions.

As shown in the examples of FIGS. 1-3, a channel being sounded based on a CSI-RS/SRS is not a physical radio channel but a channel corresponding to a CSI-RS port or an SRS port.

In some embodiments, a network (e.g., a base station) can configure a report configuration to a device. The device can perform a channel measurement and report measurement results to the network based on the report configuration. For example, the report configuration can specify a set of quantities to be reported. The quantities can include channel-quality indicator (CQI), rank indicator (RI), and precoder-matrix indicator (PMI), jointly referred to as channel-state information (CSI). The quantities can also include reference-signal received power (RSRP) reflecting a received signal strength.

The report configuration can further specify downlink resource(s) one which measurements can be performed to derive the specified quantities. For example, the report configuration may describe one or more CSI-RS resource sets each including one or more CSI-RS. For example, a single multi-port CSI-RS can be configured for reporting a combination of CQI, RI, and PMI for link adaptation and multi-antenna precoding. Multiple CSI-RS can be configured for beam management, and each CSI-RS can be beamformed and transmitted in different direction. In some scenarios, a device may perform measurements based on the configured resources without reporting. For example, a device may perform measurement for receiver-side beam forming and multi-antenna precoding without reporting.

The report configuration can further describe when and how the reporting be carried out. For example, the reporting can be periodic, semi-persistent, or aperiodic. The reporting can be activated (deactivated) based on MAC CE or triggered by means of DCI. The measurement results for periodic and semi-persistent reporting can be carried in a physical uplink control channel (PUCCH). The measurement results for aperiodic reporting can be carried in a physical uplink shared channel (PUSCH).

2. Multi-Antenna Transmission

A. Digital and Analog Multi-Antenna Processing

FIG. 4 shows a linear multi-antenna transmission scheme in a transmitter according to embodiments of the disclosure. As shown, N_{L} layers of data (such as modulation symbols) are mapped to N_{T} transmit antennas by means of multiplication with a transmission matrix W of size N_{T}×N_{L}. The vector X represents the N_{L} layers of data. The vector Y represents N_{T} signals corresponding to the N_{T} antennas.

In various examples, the multi-antenna processing, represented by the matrix W, can be applied in an analog part of a transmitter chain or a digital part of the transmitter chain. Or, a hybrid approach can be adopted where the multi-antenna processing can be applied in both the analog and digital parts of the transmitter chain. Accordingly, a multi-antenna processing can be an analog multi-antenna processing, a digital multi-antenna processing, or a hybrid multi-antenna processing in various embodiments.

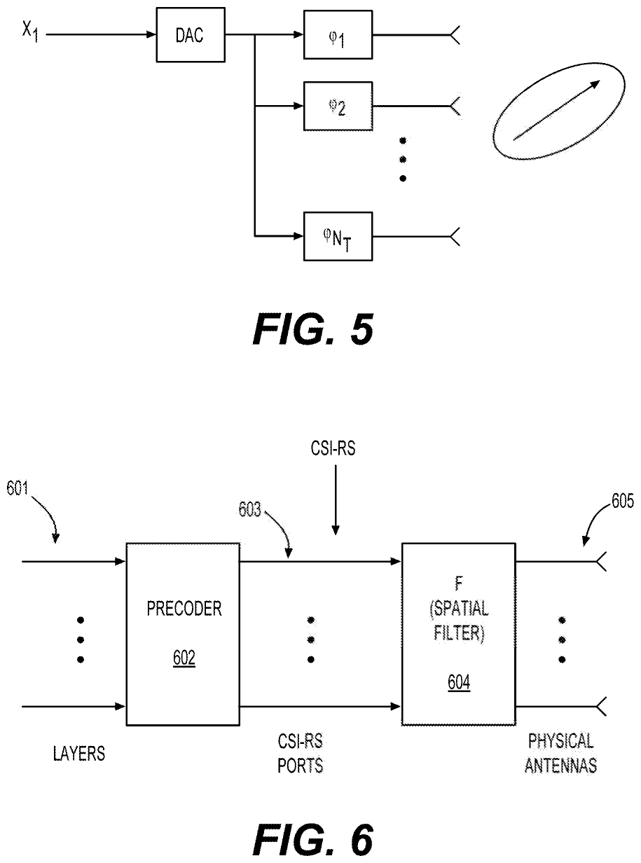

In the case of analog processing, a spatial filter, F, can be applied to provide per-antenna phase shifts to form a transmission beam. FIG. 5 shows an example of analog multi-antenna processing. In some examples, analog processing is carried out on a per-carrier basis for downlink transmission. Thus, no frequency multiplex beam-formed transmissions are performed towards devices located in different directions relative to a base station. To cover different devices located in different directions, a beam sweeping is performed by the analog processing.

In the case of digital processing, each element of the transmission matrix W can include both a phase shift and a scale factor, which provides a higher flexibility for controlling beam forming directions. For example, simultaneous multi-beam forming can be obtained to cover multiple devices located in different directions relative to a base station. A transmission matrix W used in digital multi-antenna processing is referred to as a precoder matrix. The corresponding multi-antenna processing is referred to as multi-antenna precoding.

A precoder and a spatial filter can be sequentially connected in hybrid multi-antenna processing to form directional transmission beams. FIG. 6 shows an example of hybrid multi-antenna processing according to some embodiments of the disclosure. As shown, layers of modulation symbols 601 are mapped to CSI-RS antenna ports 603 by means of a precoder 602. Outputs from the precoder 602 are mapped to physical antennas 605 by means of a spatial filter (F) 604. In some examples, the spatial filter 604 is used to form a broader beam, while the precoder 602 is used to form one or more narrower beams along the direction of the broader beam. By selecting a specific precoder 602 and a spatial filter 604, a transmitter can determine one or more beams to cover one or more receivers distributed at different locations.

Similar to transmitter side processing, a receiver can apply analog, digital, or hybrid multi-antenna processing for beam-formed reception of signals arriving from different directions.

B. Downlink Multi-Antenna Precoding

In some embodiments, to support network selection of precoder for downlink transmission (such as physical downlink shared channel (PDSCH) transmission), a device can perform measurement based on CSI-RS and report measurement results (such as a CSI report) to the network based on configurations (such as a CSI report configuration) received from the network. The network can then determine a precoder(s) based on the measurement results.

In some examples, a CSI report can include a rank indicator (RI), a precoder-matrix indicator (PMI), a channel-quality indicator (CQI), or the like. The RI can indicate a suitable transmission rank (a number of transmission layer N_{L}) for downlink transmission. The PMI can indicate a suitable precoder matrix M corresponding to the selected rank. The CQI can indicate a suitable channel-coding rate and modulation scheme given the selected precoder matrix.

In some embodiments, a value of the PMI can correspond to one specific precoder matrix selected from a precoder codebook. The precoder codebook provides a set of candidate precoder matrices. In addition to the number of transmission layer N_{L}, the device selects a PMI based on a certain number of antenna ports (N_{RS}) of configured CSI-RS associated with the CSI report configuration. In an example, at least one codebook is provided for each valid combination of N_{T} and N_{L}.

In some embodiments, two types of CSI are defined corresponding to different scenarios: Type I CSI and Type II CSI. Different types of CSI are associated with different sets of precoder codebooks having different structures and sizes.

The code books for Type I CSI can be relatively simple and aim at focusing transmitted energy at a target receiver. The type I CSI can include two subtypes: Type I single-panel CSI and Type I multi-panel CSI. The two subtypes correspond to different antenna configurations on a network or transmitter side. The codebooks for Type II CSI can provide channel information with higher spatial granularity than Type I CSI. Type II CSI can target a multi-user Multiple-Input Multiple-Output (MIMO) (MU-MIMO) scenario.

C. Uplink Multi-Antenna Processing

In some embodiments, a device can be configured in two different modes for uplink (PUSCH) multi-antenna precoding: codebook-based transmission and non-codebook-based transmission. The selection between these two modes can partly depend on whether uplink/downlink channel reciprocity can be assumed.

Typically, codebook-based precoding can be used when uplink/downlink reciprocity does not hold. For example, a device configured for codebook-based PUSCH can typically be configured for transmission of one or more multi-port SRS. The network measures the uplink channel based on the configured SRS and determines a suitable uplink precoding. The network decides on an uplink transmission rank (a number of layers to be transmitted) and a corresponding precoder matrix to use for the transmission. For example, the network can select a precoder matrix from a set of available precoders (an uplink codebook) based on a given combination of a number of antenna ports NRS (SRS ports of a configured SRS) and the transmission rank.

The network informs the device about the selected rank and precoder matrix in an uplink scheduling grant. The device accordingly applies the precoder matrix for a scheduled PUSCH transmission, mapping the indicated number of layers to respective SRS antenna ports.

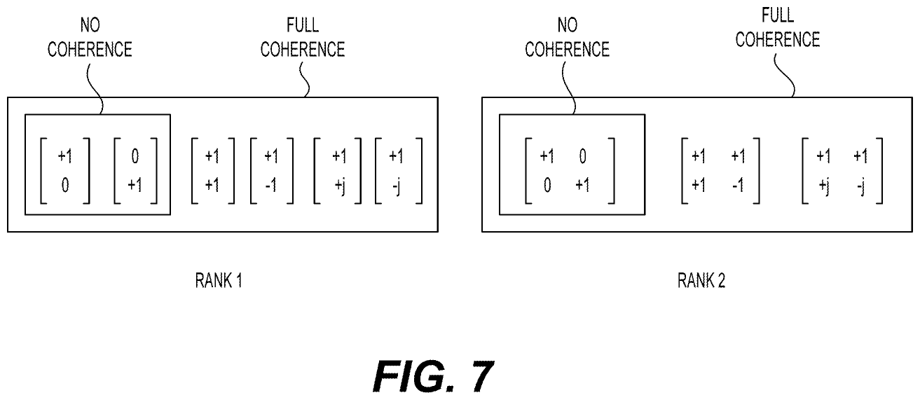

FIG. 7 shows an example of available precoder matrices (two codebooks) for a case of two antenna ports according to an embodiment of the disclosure. The first codebook (the left one) corresponds to single-rank transmission, while the second codebook (the right one) corresponds to rank-2 transmission. Different candidate precoder matrices are available depending on the antenna-port coherence property of the two antenna ports.

In some examples, a device can be configured with multiple antenna panels towards different directions relative to the device. Each antenna panel can include an array of cross-polarized antenna elements. For each antenna panel, different transmission beams can be formed by applying different spatial filters, F, between a set of SRS antenna ports and the array of cross-polarized antenna elements. During uplink channel sounding, multiple multi-port SRS can be transmitted from the device. Each of the multiple multi-port SRS can correspond to a beam (that corresponds to a respective spatial filter and a respective antenna panel).

After a measurement based on the transmitted SRS, the network can feedback an SRS resource indicator (SRI) together with an RI and a TPMI to the device, for example, as part of a DCI. (A PMI for uplink precoder can be referred to as a transmission PMI (TPMI).) The device can then perform a PUSCH transmission using the precoder indicated by the TPMI and the antenna panel and the spatial filter corresponding to the indicated SRI.

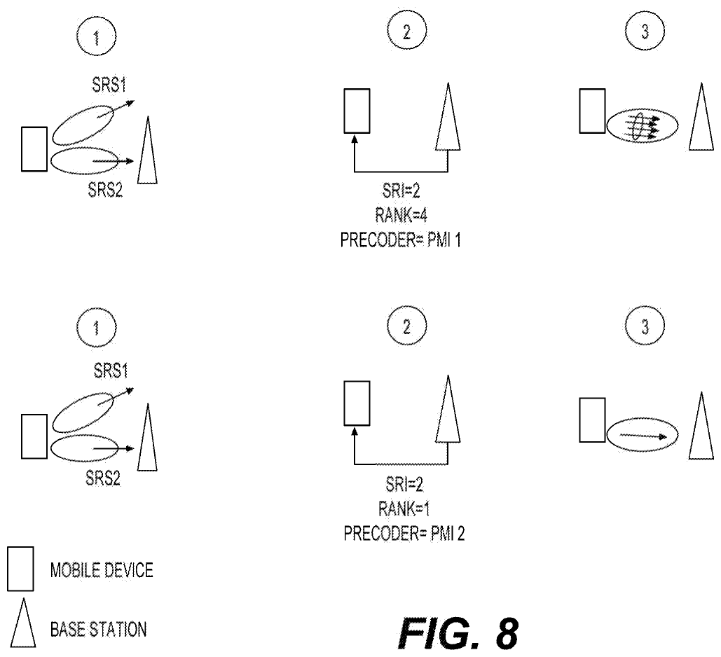

FIG. 8 shows two examples (upper part and lower part) of uplink codebook-based transmission according to embodiments of the disclosure. The two examples can each include three steps labeled with 1, 2, and 3. In both examples, a mobile device transmits two SRS, SRS 1 and SRS 2, along two beam directions to a base station. For example, the two beam directions can correspond to two antenna panels.

In the upper example, the base station feedbacks SRI=2, Rank=4, and Precoder 1. Accordingly, the mobile device can perform a rank-4 transmission with Precoder 1 over a beam corresponding to SRS 2 indicated by SRI=2. In the lower example, the base station feedbacks SRI=2, Rank=1, and Precoder 2. Accordingly, the mobile device can perform a single-rank transmission with Precoder 2 over a beam corresponding to SRS 2 indicated by SRI=2. As shown, the SRI received from the network determines what beam/panel to use for the transmission, while the precoder information (the number of layers and the precoder) determines how the transmission is performed within the selected beam.

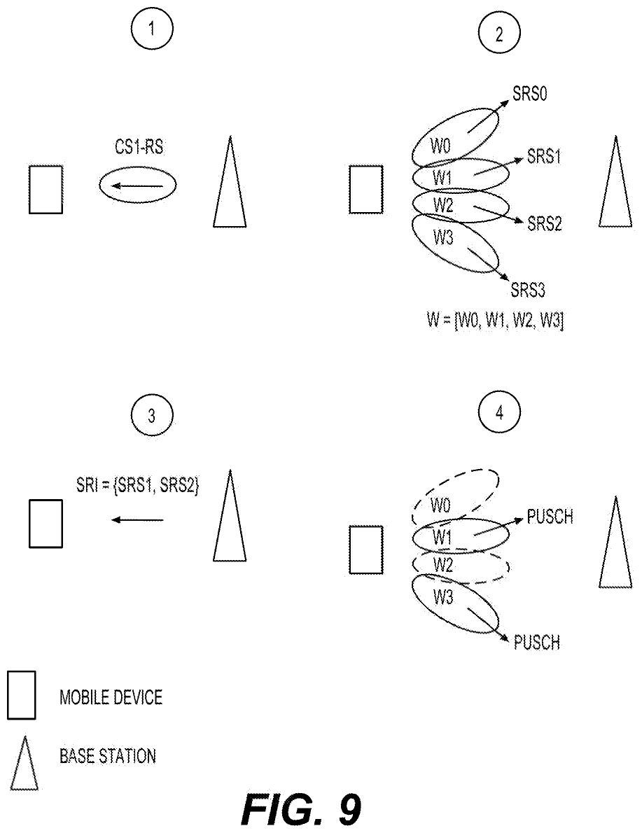

Non-codebook-based precoding can be used when an assumption of channel reciprocity holds. The mobile device can acquire detailed knowledge of an uplink channel based on downlink measurement and select an uplink multi-layer precoder. FIG. 9 shows an example of uplink non-codebook-based transmission according to some embodiments of the disclosure. The example shows four steps labeled from 1 to 4 performed by a device and a base station.

In the first step, the device measures a configured CSI-RS transmitted from the network (a base station). The device can determine a precoder based on the measurement results. For example, the precoder can be a precoder matrix W=[w1, w2, w3, w4], where w1, w2, w3, and w4 represent four column vectors corresponding to four layers (rank-4 transmission). Each column of the precoder matrix W can be seen as defining a digital beam for transmission of the respective layers.

In the second step, the device applies the selected precoder to a set of four configured SRS with one SRS transmitted on each layer (or beam) defined by the precoder. The network can perform measurements based on the set of SRS. As shown, four SRS, {SRS0, SRS1, SRS2, SRS3}, are transmitted along four beams corresponding to w1, w2, w3, and w4.

In the third step, based on measurements on the received SRS, the network can decide to modify the device-selected precoder for a specific scheduled PUSCH transmission. For example, the network can select a subset of precoder beams from the set of four beams. The network can then indicate the beam selection by indicating a subset of preconfigured SRS within an SRS resource indicator (SRI) included in a scheduling grant associated with the PUSCH. As shown, the SRI={SRS1, SRS3} is transmitted from the network to the device.

In the last step, the device carries out the scheduled PUSCH transmission using a reduced precoder W=[w1, w3] (rank-3 transmission). As shown, the PUSCH is transmitted along two beams corresponding to w1 and w3.

During the above process, the uplink precoder originally decided by the device is optimized by the network based on the measurements by the network. The first step of CSI-RS transmission for downlink channel sounding and the second step of SRS transmission for indicating the selected uplink precoder can be performed periodically. The last two steps of SRI indication and PUSCH transmission can be performed for each scheduled PUSCH transmission.

II. Simultaneous Uplink Transmission from Multiple UE Antenna Panels to One or Multiple TRPs

It is noted that, in the present disclosure, for some examples, selection of a certain number (e.g., two) of panels from a certain number (e.g., three) of candidate panels at a UE or a mobile device is used as an example to explain the related techniques, processes, or embodiments. However, the disclosure is not limited to a particular number of antenna panels configured at a UE or a particular number of antenna panels selected from the configured UE antenna panels. For example, when other numbers of UE panels or selected panels are employed in various applications, the respective numbers of configured SRS resources or resource groups may vary; and the respective numbers of TCI states or SRI may vary. Generally, a number of any parameters corresponding to two selected UE panels can be adjusted to correspond to other number of elected UE panels, such as three, four, or more active UE panels.

In addition, antenna panels are used as an example in this disclosure. However, the disclosure is not limited to antenna panels. In place of an antenna panel, there can be an antenna group. An antenna group may include one or more multiple antenna panels. Antenna ports of one antenna group can be operated together in a way similar to operating an antenna panel as described herein. Thus, techniques, processes, or embodiments applied to antenna panels as described herein can be applied to antenna groups.

Further, while some examples described herein cite a particular number of antenna ports of an antenna panel or antenna group, the techniques, processes, or embodiments can be applied to an antenna panel with any number of antenna ports.

1. Selection of UE Antenna Panels

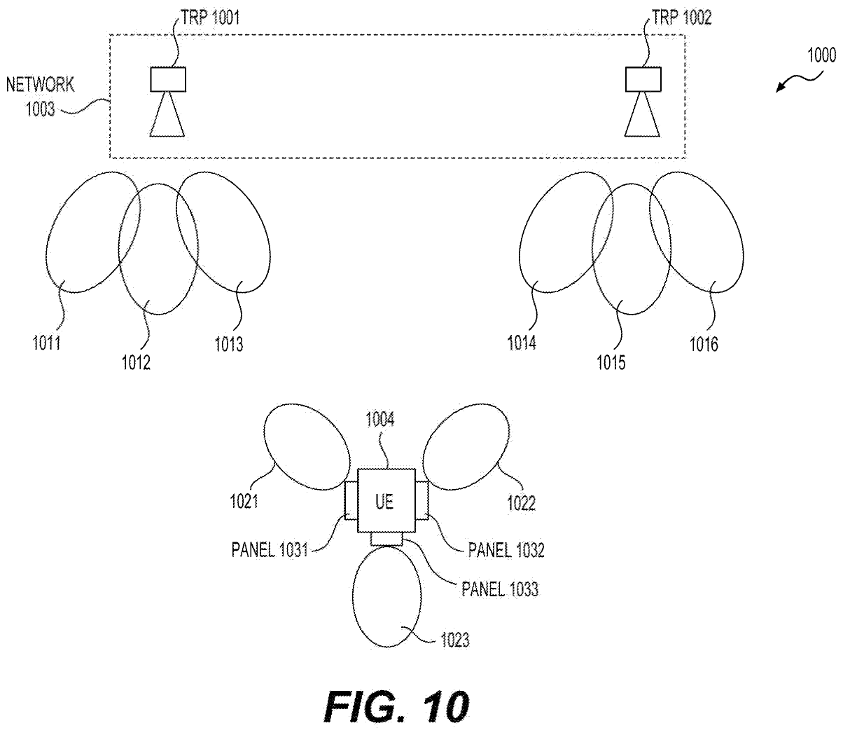

In some embodiments, a mobile device (also referred to as a user equipment (UE) in the present disclosure) can be equipped with multiple antenna panels (for example, more than 2). The network and the UE can cooperate with each other to determine which of the multiple antenna panels to use for uplink transmission. The network can indicate selected panels to the UE for uplink transmission of scheduled PUSCH based on RRC configuration, MAC CE command, and/or DCI indication. FIG. 10 shows an example where selection of UE antenna panels is carried out in a wireless communication system 1000.

The system 1000 includes a UE 1004 and a network 1003. The UE 1004 has been configured with three antenna panels 1031-1033. Each antenna panel 1031-1033 has an array of cross-polarized antenna elements. The UE 100 can be a mobile phone, a computer, a communication terminal installed in a vehicle, or the like. The network 1003 can include one or more transmission/reception point (TRP). Each TRP can have one or more antenna panels. The UE 1004 can communicate with the TRPs, for example, based on communication standards developed by the 3rd generation partnership project (3GPP) or other communication protocols. In the FIG. 10 example, the UE 1004 are shown to operate with two TRPs 1001-1002. In some examples, the TRPs 1001-1002 can be controlled by a same base station (such as a gNB) and thus can operate coordinately. In some examples, the TRPs 1001-1002 can be controlled by two base station (such as two gNB), respectively. The two base station can operate with each other. The two TRPs can thus operate coordinately.

The system 1000 can be a beam forming system. The UE 1004 and the TRPs 1001-1002 can communicate based on transmission (Tx) or reception (Rx) beams. As an example, the TRP 1001 is capable of forming the Tx (or Rx) beams 1011-1013, while the TRP 1002 is capable of forming the Tx (or Rx) beams 1014-1016. The UE 1004 can form Rx (or Tx) beams 1021-1023 each corresponding to one of the panels 1031-1033.

At an initial stage (initial connection establishment stage), the network 1003 and the UE 1004 can interact with each other to establish an initial connection using a beam pair, such as the pair of beams 1013 and 1021 (assuming the reciprocity). In an example, the network 1003 may perform one or more rounds of beam sweeping through the Tx beams 1011-1016 each applied to an SSB. The UE 1004 may perform one or more rounds of beam sweeping through Rx beams 1021-1023. Based on measurements of signal strengths of the SSBs at the UE 1004, a subset of beam pairs can be determined and reported from the UE 1004 to the network 1003. In some examples, the Tx beams 1011-1016 each can be associated with a specific reference signal (such as an SSB or a CSI-RS). The UE 1004 can thus use indexes of the respective SSB or CSI-RS to indicate the beams with the best qualities (highest strengths). The UE 1004 may or may not indicate the respective Rx beams.

For downlink transmission of a PDSCH, the network 1003 can select one of the reported beams and inform the UE 1004 the selection. The indication of the selection can be based on a transmission configuration indication (TCI) scheme. For example, a set of TCI states can be configured to the UE 1004. Each TCI state can indicate one of the reference signals (CSI-RS or SSB) among other information. A TCI state can be indicated in a DCI scheduling the PDSCH to indicate the respective reference signal. At the UE side, the UE 1004 can know the respective reference signal (an equivalent of the Tx beam of the network 1003). Accordingly, the UE 1004 can determine a Rx beam associated with the Tx beam for reception of the PDSCH. As can be seen, the TCI scheme can be used to indicate a Rx beam at the UE 1004 for downlink transmission.

In a similar way, the TCI state indicating a downlink reference signal can be used to indicate a Tx beam at the UE 1004 for transmission of PUSCH or SRS when the downlink/uplink reciprocity holds.

With the initial connection, the UE 1004 can report its uplink capabilities (among other capabilities) to the network 1003 (such as a gNB). In an example, the UE uplink capabilities can include the number of total panels, the number of simultaneously active panels (and/or panel combination), per-panel port number, full-power/non-full-power capability, and/or coherent/non-coherent transmission capability. In an example, the UE 1004 can report the uplink capabilities as three panels 1031-1033, each panel having 2 antenna ports, and two simultaneously activated UL panels (4 ports capable of simultaneous transmission).

The above initial connection can be based on the single panel 1031 forming the beam 1021, for example. At a certain stage, the UE 1004 may wish to use two panels for simultaneous uplink transmission to obtain a higher data rate, for example. Also, due to random rotation of the UE 1004 or signal blocking of a nearby object, for example, the UE 1004 may want to switch two active panels to another group of panels. In these scenarios, the network 1003 and the UE 1004 can cooperate to determine which two panels to select from the three candidate panels according to the disclosure.

In a first approach, the network 1003 (e.g., a gNB) can use downlink (DL) TCI(s) for uplink (UL) spatial filtering/spatialRelationInfo indication and let the UE select the UL transmission panels corresponding to the TCI(s) for SRS/PUSCH/PUCCH transmission. One DL TCI (or TCI state) can be used for the single-TRP case and at least two DL TCIs (TCI states) can be used for the multiple-TRP case.

In the FIG. 10 example, the network 1003 may periodically or semi-persistently perform beam sweeping to transmit SSBs or CSI-RS using the beams 1011-1016. The UE 1004 may periodically measure and report measurement results. The measurement results may indicate a list of Tx beams of the network 1003 with the highest qualities (signal strengths), for example.

For an uplink transmission of an SRS/PUSCH/PUCCH, the network 1003 may signal two TCI states to indicate two Tx beams among the reported Tx beams in response to a request of the UE 1004 to use two panels. The indicated two Tx beams correspond to the two TRPs 1001-1002, respectively. For example, the two TCI states can be signaled through a MAC CE or a DCI. For example, each TCI state may indicate an index of an SSB or CSI-RS previously transmitted from the TRP 1001 or the TRP 1002. The UE 1004 may select two panels corresponding to the two Tx beams, respectively, for the uplink transmission based on the prior measurement results (beam pair qualities).

In some examples, when one TRP (not two) is used, the network 1003 may signal one TCI state. The UE 1004 may select two panels based on the one TCI state. For example, the Rx beams of the selected two panels at the UE 1004 can have the highest beam pair quality among all Rx beams when paired with the Tx beam indicated by the one TCI state.

In the first approach, the network 1003 may not have the knowledge of the corresponding relationship between UE-reported network Tx beams and the UE panels. Thus, when providing the TCI states to the UE 1004, it is possible the TCI states may correspond to a same UE panel.

In a second approach, the network 1003 (e.g., a gNB) can configure a group-based beam measurement (BM) report to the UE 1004. The UE 1004 can thus feedback the report with information of panels or antenna ports. For example, three beam report groups are configured for each panel. When reporting, one or more TRP beams corresponding to each antenna panel are reported. Accordingly, three groups of TRP beams are reported for the three panels 1031-1033. The network can use the reported two best TRP beams of two beam groups to configure TCIs for uplink spatial filtering/spatialRelationInfo of an SRS/PUSCH/PUCCH transmission.

The network 1003 may periodically or semi-persistently perform beam sweeping to transmit SSBs or CSI-RS using the beams 1011-1016. The UE 1004 may periodically measure and report measurement results. The measurement results may indicate a Tx beam of the network 1003 corresponding to each panel 1031-1033 and an RSRP associated with each reported beam. In this way, information of the panels can be conveyed to the network 1003. Based on the report, the network 1003 can select two TRP Tx beams (an equivalent of selecting of two UE panels) for an SRS/PUSCH/PUCCH transmission. Similarly, TCI states can be signaled by means of DCI or MAC CE to the UE 1004.

In an example, the group-based BM report configuration may indicate three beam groups. Each group may include beam pairs between each of the Tx beams 1011-1016 and one of the Rx beams 1021-1023. Thus, each group of six beam pairs is associated with one UE Rx beam that corresponds to one panel at the UE 1004. When reporting, the highest beam pair RSRP in each beam group can be reported for each beam group. Various beam grouping methods can be employed to realize the above indication of panel information at the UE 1004.

The above two approaches can be based on the assumption that uplink and downlink reciprocity is held. Accordingly after a UE Rx beam is determined based on a received TCI state, the same spatial filter corresponding to the determined UE Rx beam can be used for a UE Tx beam for an SRS/PUSCH/PUCCH transmission.

In a third approach, the network 1003 (e.g., a gNB) can configure at least three SRS resources for panel selection and beam measurement. For example, the SRS resource configuration can be signaled by radio resource control (RRC) signaling. For example, an RRC message may be signaled that includes an indication of “usage=M-panel selection”, indicating the configured SRS resources are for multiple panel selection. The network 1003 may trigger an SRS transmission from the UE 1004 using the configured SRS resources, for example, by means of MAC CE or DCI. For beam panel selection beam measurement, the SRS with the configured SRS resources can be transmitted repeatedly for gNB beam training (or beam sweeping) in some examples.

For example, the configured SRS resources can correspond to the three panels 1031-1033, respectively. The UE 1004 can transmit the SRS using the configured SRS resources from the respective panels 1031-1033. The different panels can perform the transmission simultaneously (if the UE capability allows) or at different time instances. The network 1003 can perform Rx beam sweeping to measure the strength or quality of the SRS received on each Rx beam at the TRPs 1001-1002. For example, the metric of RSRP or signal to interference and noise ratio (SINR) can be used for the measurements.

The measurement results can include, corresponding to each of the three SRS resources (or each UE panel 1031-1033), the quality of each Rx beams at the network 1003. Based on the measurement results, the network 1003 can select two UE panels for uplink transmission. The network 1003 can then signal TCI states for uplink spatial filtering/spatialRelationInfo of an SRS/PUSCH/PUCCH transmission. For example, the TCI states may indicate two indexes of the two SRS resources corresponding to the selected two panels.

2. SRS Procedure for Codebook-Based Uplink Transmission

In some embodiments, the system 1000 can be configured to perform codebook-based uplink transmission. The codebook-based uplink transmission can include two stages. In a first stage, an unlink channel sounding process can be carried out. For example, the network 1003 can configure SRS resources (corresponding to certain number of antenna ports and certain antenna panels) to the UE 1004 based on the capability and need of the UE 1004. The UE 1004 accordingly transmit SRS using the configured SRS resources and the corresponding antenna panels. The network 1003 can measure the channel based on the SRS and determine a transmission rank and a precoder(s) (e.g., one or more precoder matrixes). In a second stage, the network 1003 can signal the transmission rank and the precoder to the UE 1004, for example, in a DCI that schedules a PUSCH. The network 1003 can also indicate respective antenna panels for the uplink transmission.

In a beam measurement process for selection of UE antenna panels and uplink and downlink beams, a single-port SRS can be transmitted from a UE panel using one (or more) antenna port. In an uplink channel sounding process, an SRS can be a multi-port SRS and transmitted through multiple SRS ports of a UE panel. In this way, a multi-antenna CSI for the purpose of selecting an uplink precoder(s) can be obtained.

The present disclosure provides two approaches for code book-based uplink transmission.

In a first approach, the network 1003 (e.g., a gNB) can configure three SRS resources (or resource groups) (e.g., usage=codebook/M-panel codebook) in an SRS resource set for the three panels 1031-1033 and triggers SRS transmission. The network 1003, based on the SRS measurement results, can obtain uplink CSI information for the three panels 1031-1033.

For example, the UE 1004 may rotate randomly. Some of the panels 1031-1033 may be blocked by a user's finger. Or, one of the panels 1031-1033 is near a user's body and thus transmission from this panel is desired to be turned off. Considering those scenarios, the UE 1004 can be configured to transmit SRS from each of the three panels 1031-1033, so that the network 1003 can determine the current status of the channel or the panels 1031-1033.

For example, the resource set can be signaled to the UE 1004 using RRC signaling. The three SRS resources can each be a multi-port SRS. The SRS transmission can be a one-time transmission or multiple (periodic) transmissions based on the resource set, for example, triggered by a DCI or MAC CE. The two Rx beams at two TRPs 1001-1002, respectively, (for example, determined based on beam measurement process) can be used for measuring the SRS in some examples. The operations of obtaining the uplink CSI information for the three panels can be periodically performed in some examples.

After obtaining the CSI information corresponding to the three panels 1031-1033, two methods can be used for precoder and panel selection or indication: gNB initiative or UE initiative.

In the method of gNB initiative, the network 1003 determines the precoder and panels used at the UE 1004. For example, the network 1003 uses a DCI grant with two TPMIs and two SRIs/TCIs by way of RRC/MAC CE codepoint to indicate the selected panels corresponding to the two TPMIs and two SRIs. The UE 1004 can follow the DCI grant to transmit a PUSCH.

For example, the DCI grant can indicate two TPMIs that indicate two uplink precoder matrixes selected from one or more codebooks. Each of the two precoder matrixes can be used corresponding to one of the two selected panels. For SRI indication, in an example, TCI states can be used. For example, an RRC message can be used for configuring a set of TCI states (e.g., 32 TCI states) to the UE 1004. A MAC CE can be used to activate a subset of TCI states (e.g., 8 TCI states). The DCI can include two codepoint values corresponding to two of the subset TCI states to indicate the target TCIs. The two Target TCIs can be associated with two of the three multi-port SRS. Accordingly, corresponding to the two multi-port SRS, the UE 1004 can determine two panels for the uplink transmission of the PUSCH.

In the method of UE initiative, the UE 1004 determines the precoder and the panels used at the UE 1004. As the UE 1004 may have the knowledge of which panels are blocked or not allowed earlier than the network 1003, this method of UE initiative may have an advantage than the method of gNB initiative. For example, the network 1003 uses a DCI grant with three TPMIs and then the UE follows the DCI grant to transmit PUSCH and PUCCH that includes information of the selected panels or TPMIs. When the UE panel information is implicit, this method is more suitable than the method of gNB initiative.

For example, the DCI grant provides the three TPMIs to indicate three precoders corresponding to the three panels 1031-1033. The DCI grant may not provide an indication of which panels are selected. The UE 1004 selects two panels from the panels 1031-1033 for transmission of the PUSCH. In the PUCCH, the UE 1004 can indicate which two panels are selected by indicating the respective two TPMIs or previously transmitted two multi-port SRS. In an example, the PUCCH can be transmitted using a beam pair determined in an initial stage or later beam measurement process.

A second approach for codebook-based transmission corresponds to the scenario where the network 1003 selects multiple TCIs to indicate selection of multiple UE panels. As described in Section II.1. UE Antenna Panels and Panel Selection indication, the network 1003 can select TCI(s) (corresponding to the selected panels) for uplink spatial filtering/spatialRelationInfo of SRS/PUCCH/PUSCH. For example, the selected panels correspond to beam pairs with best DL RSRP, RSRQ, or SINR during the measurements of the respective beam measurement process.

Given the selected UE panels, for example, the network 1003 can configure two SRS resources/resource groups (for example, usage=codebook/M-panel codebook) in an SRS resource set for the selected two panels. The selected two panels can be selected by the UE 1004 or the network 1003. The respective beam pairs of the two panels can have the best DL RSRP, RSRQ, or SINR. The network 1003 can trigger SRS transmission from the UE 1004 accordingly in a first stage. Based on the SRS measurement results, the network 1003 can obtain uplink CSI information corresponding to the two selected panels.

In a next stage, a gNB initiative method can be used for precoder selection and indication for scheduling and transmission of a PUSCH. For example, the network 1003 determines two precoders or TPMIs. The network 1003 uses a DCI grant with the two TPMIs and two SRIs/TCIs (by way of RRC/MAC CE codepoint) to indicate the selected panels. The selected two panels correspond to the two TPMIs and the two SRIs. The UE 1004 can then follow the DCI grant to transmit a PUSCH.

3. SRS Procedure for Non-Codebook-Based Uplink Transmission

In some embodiments, the UE 1004 can be configured to perform non-codebook-based uplink transmission. For example, the UE 1004 can perform channel measurements based on reference signals (SSB or CSI-RS) transmitted from the network (1003). Based on the measurement results, the UE 1004 can determine a transmission rank and a precoder(s) for UE panels for uplink transmission. When the precoder(s) is applied for transmission over a respective antenna panel, multiple uplink transmission beams may be formed from the respective panel. A next step can be to further optimize each precoder. A number of beams by each precoder can be reduced as a result of the optimization.

In the above non-codebook-based uplink transmission, SRS resource groups can be introduced. The SRS resource groups can be added in an SRS resource set. Each SRS resource group includes one or multiple SRS resources and corresponds to a panel at a UE. Each panel can use the SRS resources of the corresponding SRS resource group to perform non-codebook mode SRS transmission (using a UE-selected precoder(s)). By applying a precoder to a UE panel, SRS using the SRS resources can be transmitted in different beam directions. An alternative to the SRS resource group is to use three SRS resource set corresponding to the three panels 1031-1033. For example, a new link method can be added to link an SRI to an SRS resource set. For example, a RRC/MAC CE codepoint-based mechanism can be used for indicating the SRI.

Two approaches of the non-codebook-based uplink transmission are described below.

In a first approach of the non-codebook-based uplink transmission, the network 1003 (e.g., a gNB) can configure three SRS resource groups (usage=non-codebook) in an SRS resource set for the panels 1031-1033. The network 1003 triggers SRS transmission of the UE 1004. The network 1003 measures the transmitted SRS. In an example, the network 1003, based on the SRS measurement results, obtain uplink CSI information for the three panels 1031-1033.

For example, each SRS resource group can correspond to one of the panels 1031-1033. Each SRS resource group can include multiple SRS resources (single port or multi-port). Each of the multiple SRS resource can correspond to a beam formed by the respective precoder of the respective panel. During the SRS transmission, the precoder for each panel 1031-1033 is applied to the respective multiple SRS resources (or respective SRS). Accordingly, each SRS is transmitted along one of the multiple beams formed by the respective precoder of the respective panel. For example, the precoder matrix can include multiple columns each corresponding to a beam.

In other examples, for the precoding processing, multiple precoders are used in place of the single precoder matrix. Each of the multiple precoders may correspond to a column of the single precoder matrix. In this scenario, it is said each beam correspond to a precoder at a UE panel for non-codebook-based uplink transmission.

In a next stage of the first approach of the non-codebook-based uplink transmission, two different methods can be used: gNB initiative and UE initiative.

In the method of gNB initiative, the network 1003 selects the panels and the respective transmission beams (or precoders) of the selected panel. For example, the network or the gNB can use a DCI grant with two or more SRIs or an SRI combination (by way of RRC/MAC CE codepoint) to indicate the selected panels. The selected panels correspond to the the SRIs or SRI combination. The UE 1004 then follows the DCI grant to transmit a PUSCH.

For example, the UE 1004 can determine the selected two panels based on the DCI-indicated SRIs or SRI combination. In some examples, based on the DCI-indicated SRIs or SRI combination, the UE 1004 can also determine which column(s) of the precoder matrix of the selected panel is used (or not used), which is an equivalent to identify the respect transmission beams that are used for the uplink transmission.

In the method of UE initiative, the UE 1004 determines the panels and the respective transmission beams (or precoders). The network or the gNB uses a DCI grant with three or more SRIs corresponding to the three panels. The UE 1004 follows the DCI grant to transmit PUSCH and PUCCH. The PUCCH can be used to provide the information of the selected panels. The PUCCH can also be used to provide information of SRIs corresponding to the selected panels. If the UE panel information is implicit, the method of UE initiative is more suitable than the method of the gNB initiative.

A second approach of the non-codebook-based uplink transmission corresponds to the scenario where the network 1003 selects multiple TCIs for multiple UE panels. As described in Section II.1. UE Antenna Panels and Panel Selection Indication, the network 1003 can select TCI(s) (corresponding to the selected panels) for uplink spatial filtering/spatialRelationInfo of SRS/PUCCH/PUSCH. For example, the selected panels correspond to beam pairs with best DL RSRP, RSRQ, or SINR during the measurements of the respective beam measurement process.

For example, in the second approach, the network 1003 (e.g., a gNB) can configure two SRS resource groups (usage=non-codebook) in an SRS resource set for two selected panels of the UE 1004. The two selected panels can be previously determined and have the best RSRPs/RSRQs/SINRs. The network 1003 can trigger SRS transmission from the two panels of the UE 1004 using the two SRS resource groups. The network 1003 or the gNB, based on the measurement results of the SRS transmission, can obtain uplink CSI information for the two panels.

In a next stage, the network 1003 or the gNB can use a DCI grant with two or more SRIs or an SRI combination (by way of RRC/MAC CE codepoint) to indicate the selected panels. The selected panels correspond to the two or more SRIs or SRI combination. The UE follows the DCI grant to transmit a PUSCH.

4. Features Related with Multi-Panel Uplink Transmission

In some embodiments, a dropping rule can he implemented at the UE 1004 for dropping transmissions of channels or signals due to various reasons. For example, the reasons can include exhausted power headroom, power saving, overheating handling, or the like. For example, the to-be-transmitted channels and signals can be dropped according to the following order: data channel, reference signal (SRS), and control channel. According to this order, the data channel is the first type of element to be dropped.

When the UE 1004 uses multiple uplink panels simultaneously for uplink transmission, the UE 1004 may reduce uplink SRS power or not transmit one or more uplink SRS of all the UE panels in order to reduce transmission power. In an example, when the UE 1004 is to transmit a PUCCH and at least two SRS (SRS resources) from two panels, the UE can first drop the SRS (SRS resources) for the panel with a lower beam-pair-link quality, a lower receiving power (e.g., downlink RSRP) or a larger path loss. The parameters of beam-pair-link quality, receiving power, or path loss associated with a UE panel can be obtained in a latest beam measurement process where qualities or signal strengths of beam pairs measured.

For example, the two panels are selected based on a beam measurement process as described in Section II.1. UE Antenna Panels and Panel Selection Indication. The beam-pair-link quality of the beam pairs between the TRP Tx beams and the UE panel Rx beams are measured during the beam measurement process. Based on the two TSI states indicated by the network 1003, the UE 1004 can identify the respective beam pairs and the respective measurement results corresponding to the selected two panels at the UE 1004. These measurement results for indicating a beam-pair-link quality can be based on various metrics, such as RSRP, RSRQ, SINR, or the like.

In some embodiments, for operation of multiple active UE antenna panels, a DCI for scheduling an uplink transmission (such as PUSCH or PUCCH) can include at least two transmit power control (TPC) commands and/or timing advance (TA) commands for at least two antenna groups (or panels), SRIs, TPMIs, or TCIs. The number of the TPC commands or TA commands can be the same as the number of the active antenna groups (or panels) at the UE 1004. For example, a UE can be configured with four antenna panels and is capable of simultaneous transmission from three antenna panels. The UE may want to activate two antenna panels, for example, to save power. Corresponding to the two active antenna panels, a DCI can include two TPC command and two TA commands. By adjusting the transmit power and timing advice, the two active antenna panels can operate in a coordinate way or a coherent way. As a result, intended signals towards a target direction from two panels can constructively interfere with each other, while unwanted signals can destructively interfere with each other to reduce the interference.

In some embodiments, UE panel information can be explicit or implicit. For explicit UE panel information, a UE can use fixed indexes to indicate the indexes of the UE panels, and indicate which panel should be used for the corresponding beams. For example, in FIG. 10, the network 1003 may configure the UE 1004 to report the RSRPs of several TRP beams of the TRP 1001 and the corresponding UE panels. The UE may use 0 for the panel 1031, 1 for the panel 1032, and 2 for panel 1033. The RSRP report could include at least one set of [a TRP beam index, the panel index of the corresponding UE panel, the corresponding RSRP value] for the TRP 1001. The network 1003 can also configure the UE to do the same thing for the TRP 1002. The network 1003 can base on the information to find out which two panels are suitable to do UL transmission for the TRP 1001 and the TRP 1002 simultaneously and use the panel indexes 0, 1, and 2 to configure simultaneous UL transmission. For implicit UE panel information, a UE could indicate which TRP beams should be used for a panel and which TRP beams should be used for another panel. For example, in FIG. 10, the network 1003 may configure the UE 1004 to report the RSRPs of several TRP beams of the TRP 1001 and the TRP 1002 for simultaneous UL transmission. The RSRP report could include at least one set of [a first TRP beam index of the TRP 1001, the corresponding RSRP value, a second TRP beam index of the TRP 1002, the corresponding RSRP value] for simultaneous UL transmission to the TRP 1001 and the TRP 1002. The network 1003 can use the first TRP beam index of the TRP 1001 indexes and the second TRP beam index of the TRP 1002 to configure simultaneous UL transmission.

III. Codebook for Multi-Panel Uplink Transmission

In the FIG. 10 example, two UE panels can be selected from three candidate panels for codebook-based uplink transmission (e.g., PUSCH or PUCCH). In various embodiments, there can be two approaches for codebook design and signaling for the codebook-based multi-panel transmission: (1) using existing precoders with additional co-phasing and amplitude compensation; and (2) new codebook design with consideration of co-phasing and amplitude compensation.

1. Co-Phasing and Amplitude Compensation Between Existing Precoders

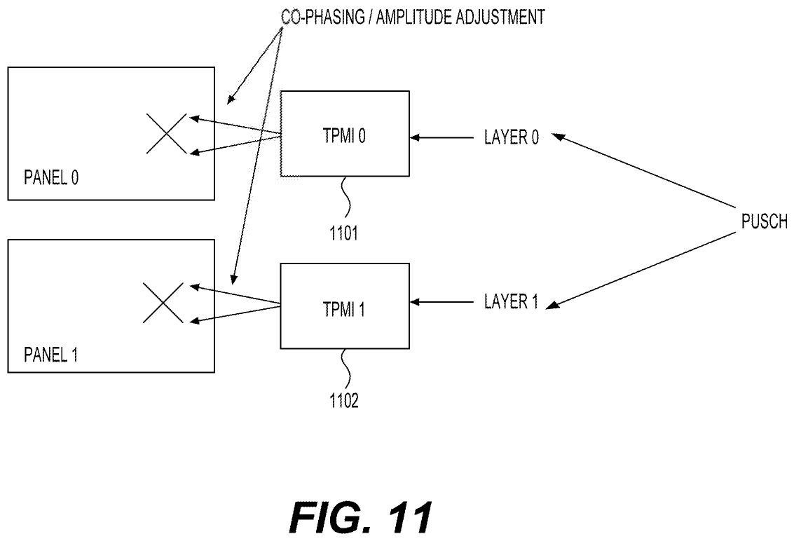

FIG. 11 shows an example of the first approach of codebook design and signaling for codebook-based multi-panel uplink transmission. In the FIG. 11 example, a PUSCH is transmitted by multi-beam spatial domain multiplexing (SDM) using two selected panels, Panel 0 and Panel 1. Each panel includes two antenna ports that are cross polarized with each other. Modulation symbols of the PUSCH can be mapped to two layers: Layer 0 and Layer 1. Layer 0 is passed to a precoder 1101 corresponding to a first TPMI, TPMI 0 (2×1 matrix). Output of the precoder 1101 is coupled to Panel 0. Similarly, Layer 1 is passed to a precoder 1102 corresponding to a second TPMI, TPMI 1 (2×1 matrix). Output of the precoder 1102 is coupled to Panel 1.

The precoder 1101 or 1102 can be selected from an existing codebook previously designed for a scenario of single-panel or multi-panel uplink transmission. To obtain an effect of coherent multi-panel transmission, co-phasing and/or amplitude related processing can be added for processing the signals output from the precoders 1101 and/or 1102. For example, a phase difference can be introduced between the signals outputs from the two precoders (co-phasing). Additionally and optionally, amplitudes of the signals outputs from the two precoders can be adjusted (amplitude adjustment).

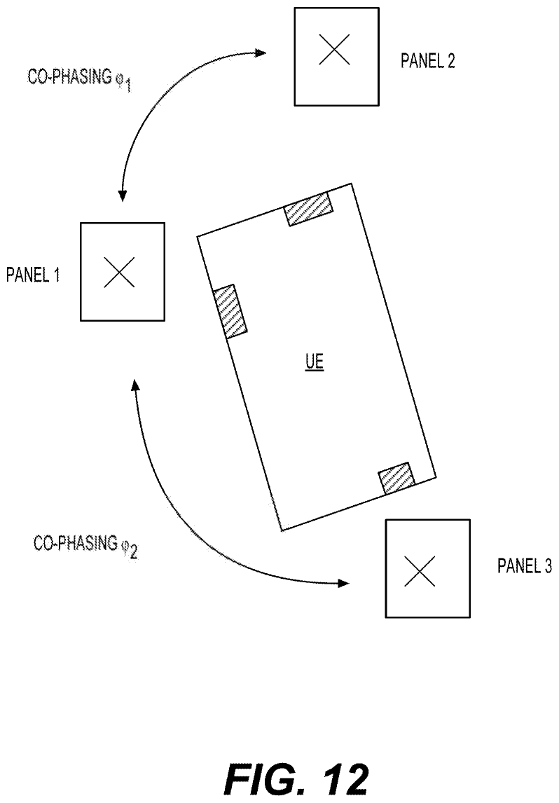

FIG. 12 shows an example of co-phasing operation at a UE according to embodiments of the disclosure. The UE is configured with three two-port antennal panels, Panel 1, Panel 2, and Panel 3. A first phase difference is applied to Panel 2 with respect to Panel 1. A second phase difference is applied to Panel 3 with respect to Panel 1.

An exemplary process for determining and signaling co-phasing and amplitude information is described below based on the FIG. 10 example. The process can include two stages.

In a first stage, the network 1003 (e.g., a gNB) can configure SRS resources to the UE 1004 and trigger SRS transmission to determine co-phasing and amplitude information. For example, the network can configure three SRS resources to the UE 1004 corresponding to the three panels 1031-1033, respectively. In an example, the three SRS resources can be frequency division multiplexed (FDMed). Each SRS resource corresponds to a two-port SRS. Alternatively, the network 1003 can configure one six-port SRS resource in an SRS resource set for the three panels 1031-1033. For example, the network 1003 can use three code division multiplexed (CDM) groups to map ports to panels. For example, each CDM group includes SRS resources corresponding to two antenna ports of each panel.

In some examples, two antenna panels have been selected from the three panels 1031-1033 for multi-panel transmission. In this scenario, the above three SRS resources can be reduced to two SRS resources, and the six-port SRS resource can be reduced to a four-port SRS resource.

The network 1003 can then trigger the UE 1004 to perform SRS transmission based on the configured SRS resources. The SRS can be transmitted at the same time from the three panels or the two selected panels. Or, the SRS can be transmitted on a panel pair-by-panel pair bases. Each panel pair of the three panels performs the transmission at the same time. The network can accordingly find out the co-phasing and amplitude information among the three or two selected panels. In some examples, the amplitude information can be in a form of transmit power information or transmit power control (TPC) information.

In a next stage, co-phasing and amplitude information is signaled and antenna panels are selected (if not yet). The network 1003 can use a DCI to indicate (1) the selected panels (if the network does the selection); and (2) the co-phasing and/or amplitude (power) information. For example, the panel indication or the co-phasing and/or amplitude (power) information can be indicated based on a way of RRC/MAC CE codepoint or based on standardized values specified in a communication standard specification. In an example, two DCI fields are used: one for indicating the selected panels and the other one for the co-phasing and/or amplitude (power) information.

In a first approach of gNB initiative, the network 1003 selects two antenna panels from candidate three panels. The DCI with a DCI field can indicate the selected panels based on SRIs or TCIs. The DCI with another one or two DCI field can indicate co-phasing and/or amplitude (power) information related with the two selected panels.

In a second approach of UE initiative, the UE 1004 selects two antenna panels (or antenna groups) from candidate three panels (antenna groups). In an example, the DCI can indicate three candidate panels 1031-1033 and co-phasing and/or amplitude information related with the three candidate panels. In an example, the DCI indicates three co-phasing and/or amplitude information corresponding to each panel pair of the three panels 1031-1033. The UE 1004 follows the DCI grant to transmit PUSCH and PUCCH with the information of the signaled information.

For example, the UE 1004 can select two panels from the three panels 1031-1033, for example, based on local knowledge of the antenna panel status (e.g., which antenna is blocked or not allowed). The UE 1004 can derive uplink transmission timings (e.g., cyclic delay diversity) for the selected two panels based on the received co-phasing information (phase difference between the selected panels). Or, the UE 1004 can derive a frequency-domain phase compensation for the selected two panels based on the received co-phasing information. In some examples, the DCI can have at least two TPC command fields to indicate the amplitude information: one for a first selected antenna panel (antenna group) and the other for a second selected antenna panel (antenna group).

2. New Codebook Design with Consideration of Co-Phasing and Amplitude Compensation

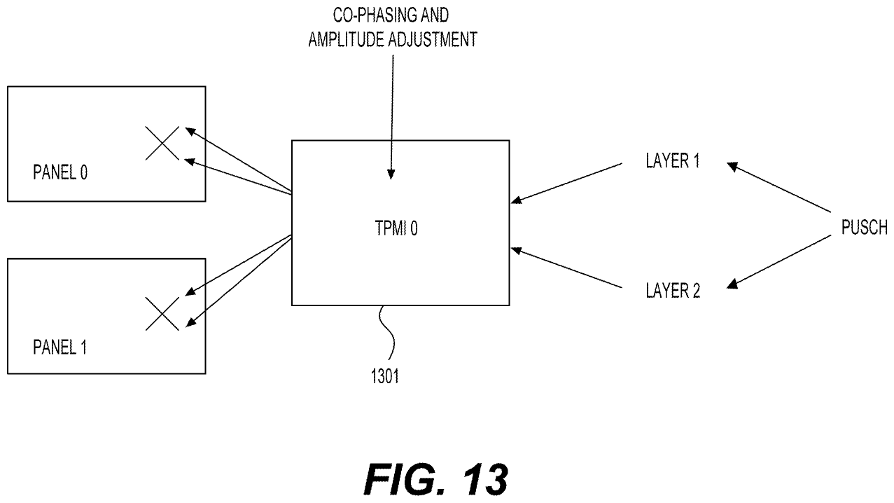

FIG. 13 shows an example of the second approach of codebook design and signaling for codebook-based multi-panel uplink transmission. Similar as in the FIG. 11 example, in FIG. 13, a PUSCH is transmitted using multi-beam SDM. Two layers (Layer 0 and Layer 1) of the PUSCH are transmitted using two selected panels, Panel 0 and Panel 1. The two selected panels have similar configurations as the panels in FIG. 11. However, in the place of the precoders 1101-1102, a single precoder 1301 is employed. The precoder 1301 corresponds to a TPMI, TPMI 0. The precoder 1301 can be selected from a codebook which, when designed, considers the co-phasing and amplitude adjustment applied to the two transmission panels as described in the FIG. 11 example. Accordingly, when the precoder 1301 is applied to the input Layer 0 and Layer 1 signals, phases and amplitudes of the output signals from the precoder 1301 can be adjusted such that the two portion signals from Panel 0 and Panel 1 can be transmitted in a coherent manner.

Comparing with the FIG. 11 example, in an exemplary process based on codebooks with co-phasing and amplitude adjustment being considered, SRS resources can be configured to the UE 1004 in a similar way. Based on SRS measurement, the network 1003 can determine a precoder for each pair of panels among the three panels 1031-1033. Depending on if the two panels are already selected before the SRS transmission and which of the two approaches (gNB initiative or UE initiative) is adopted, the network 1003 can signal one or three TPMIs to the UE 1004. For example, if two panels are previously selected in a beam measurement process, or a method of gNB initiative is used, one TPMI can be signaled for two selected panels. Otherwise, for a method of UE initiative, three TPMIs can be signaled corresponding to each of three pairs of UE panels. The UE 1004 can accordingly apply a signaled precoder to an uplink transmission of PUSCH or PUCCH using two selected panels.

IV. Exemplary Processes for Multi-Panel Uplink Transmission

### EXAMPLE 1

### SRS Procedure for Codebook-Based Transmission

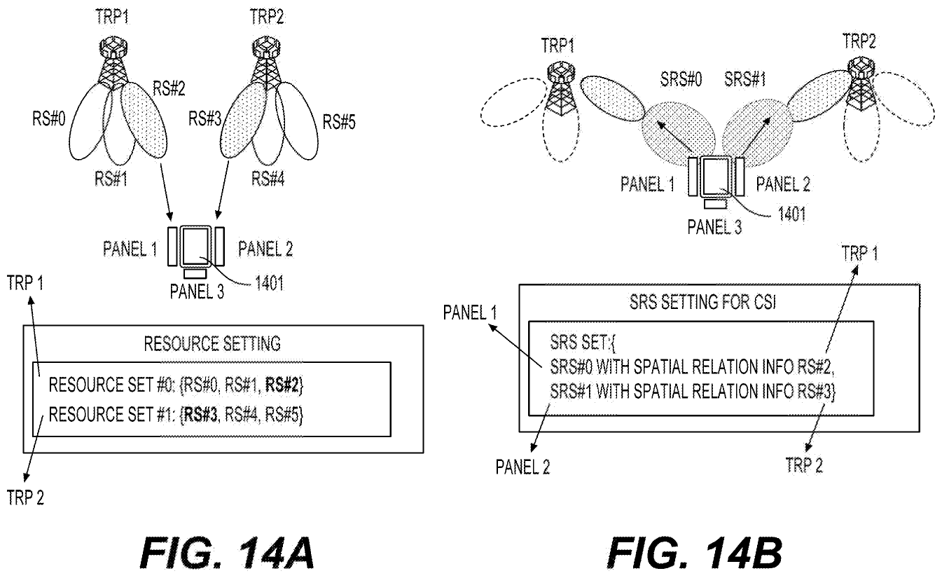

Example 1 is related with an SRS procedure for Codebook-Based Transmission and described with reference to FIG. 14A and FIG. 14B. The SRS procedure of Example 1 can include multiple stages. FIG. 14A shows a stage of UE panel selection. FIG. 14B shows a stage of CSI acquisition. As shown in FIGS. 14A-14B, a gNB has two TRPs, “TRP1” and “TRP2”, with six Tx beams and a UE 1401 has three panels.

Stage 1: UE Panel Selection

As shown in FIG. 14A, the gNB configures two resource sets #0 and #1 individually associated with the two TRPs for beam measurement. There are three DL RS resources associated with three Tx beams in each resource set. The DL RS resources can be CSI-RS or SSB resources. By using group-based beam reporting, the UE 1401 reports the RS indexes of the DL RS resources with the highest RSRPs or SINRs, such as RS#2 and RS#3. DL transmissions from the beams corresponding to the RS#2 and RS#3 can be received simultaneously and individually by two panels of the UE 1401.

Stage 2: CSI Acquisition

As shown in FIG. 14B, the gNB configures two SRS resources, SRS#0 and SRS#1, in an SRS resource set for CSI acquisition (Usage=codebook or M-panel codebook). The two SRS resources have spatialRelationInfos or UL TCIs associated to RS#2 and RS#3, respectively. With the spatialRelationInfos or UL TCIs, the UE 1401 knows which panel/beam is more proper for transmitting which SRS resource, and the gNB knows the corresponding received beams setting.

The UE 1401 uses Panel 1 to transmit SRS#0 and Panel 2 to transmit SRS#1. Based on beam correspondence, TRP1 can receive SRS#0 by using the beam associated to RS#2, and TRP2 can receive SRS#1 by using the beam associated to RS#3. The gNB can measure SRS#0 to derive a TPMI1 and SRS#1 to derive a TPMI2 for Panel 1 and Panel 2, respectively.

Stage 3: DCI Indication

The gNB can use a DCI grant with two SRIs={0, 1} (SRS index: SRS#0 and SRS#1) or one SRI codepoint={2} for the UE 1401 to indicate that Panel#1 and Panel#2 are selected for UL transmission. Moreover, the gNB can use the DCI grant with the two TPMIs (TPMI1 and TPMI2) to indicate the precoders for PUSCHs transmission. In an example, the relation between an SRI codepoint and at least one selected UE panel or TRP can be signaled by UE-specific RRC or MAC-CE. In another example, the relation between an SRI codepoint and at least one selected UE panel or TRP is not signaled.

Stage 4: Uplink Transmission

The UE 1401 follows the DCI grant to transmit PUCCH and/or PUCCH using the indicated panels and precoders.)

### EXAMPLE 2

### SRS Procedure for Codebook-Based Transmission

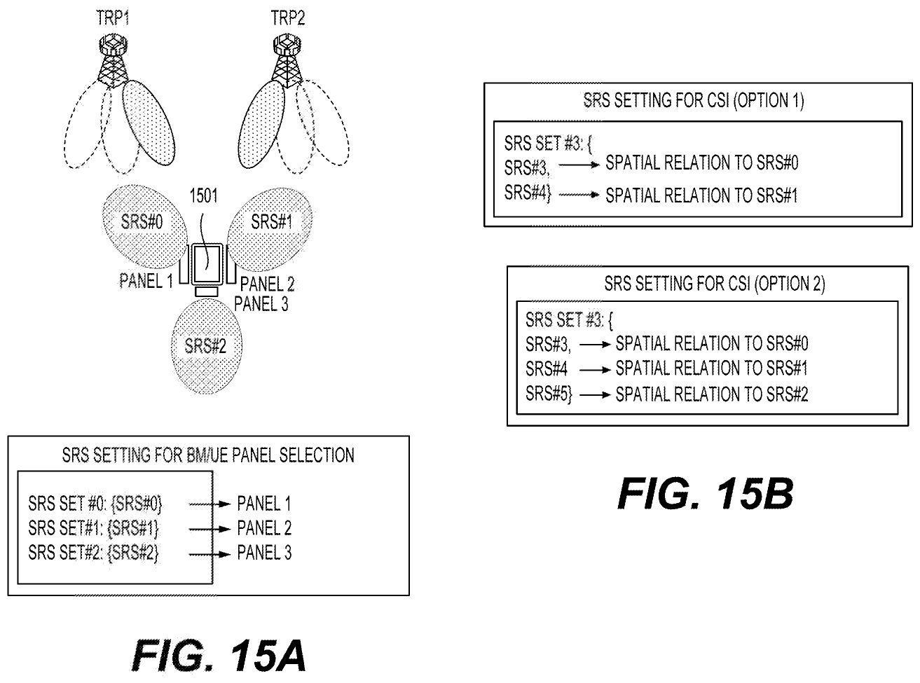

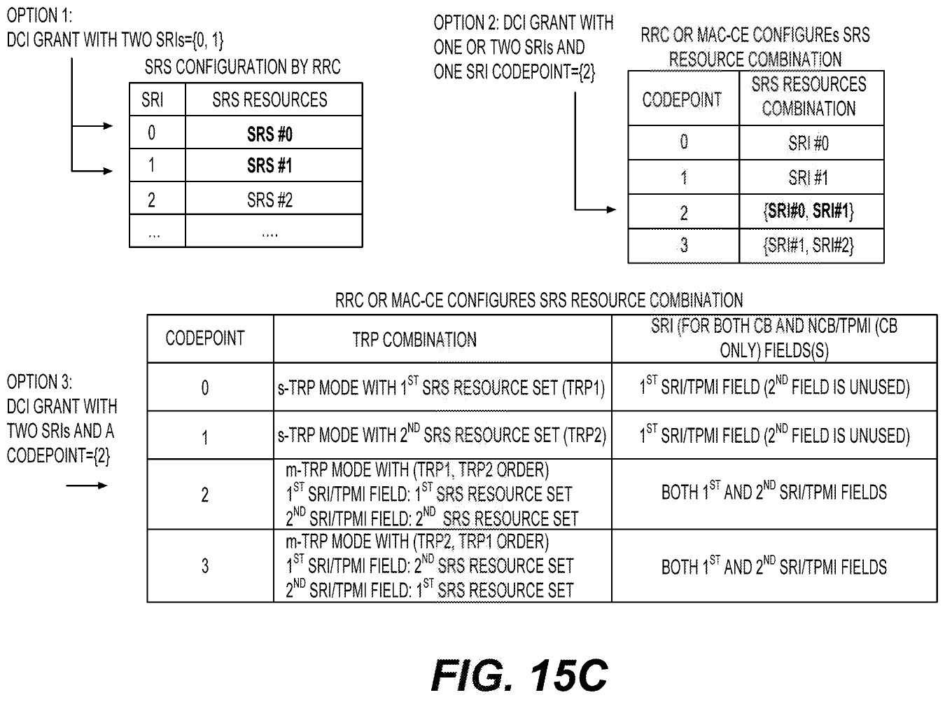

Example 2 is related with another SRS procedure for Codebook-Based Transmission and described with reference to FIGS. 15A-15C. The SRS procedure of Example 2 can include multiple stages. FIG. 15A shows a UE panel selection stage. FIG. 15B shows SRS resource configurations at a stage of CSI acquisition. FIG. 15C shows options of DCI indication schemes at a stage of DCI indication. As shown in FIGS. 15A, a gNB has two TRPs, “TRP1” and “TRP2”, with six Tx beams and a UE 1501 has three panels.

Stage 1: UE Panel Selection

As shown in FIG. 15A, the gNB configures three SRS resource sets for the UE 1501 to perform UL panel selection or beam measurement. The three resource sets are implicitly associated with the three UE panels. If the gNB doesn't have the Rx beam information, the gNB can configure repetitive SRS resources with a repetition factor for beam training (e.g., with beam sweeping). The UE 1501 can use Panel 1, Panel 2 and Panel 3 to transmit SRS resources #0, #1 and #2, respectively.

The gNB can select the best two panels with the best RSRPs or SINRs for PUSCH transmission base on the measurement results of the three SRS resources.

Stage 2: CSI Acquisition

There can be two options for CSI acquisition shown in FIG. 15B. In a first option (Option 1), the gNB selects the best two panels and configures two SRS resources corresponding to the selected panels for CSI acquisition (Usage=codebook or M-panel codebook). The UE 1501 can use Panel 1 to transmit SRS#3 and Panel 2 to transmit SRS#4. The gNB can measure SRS#3 to derive TPMI1 and measure SRS#4 to derive TPMI2 for Panel 1 and Panel 2, respectively.

In a second option (Option 2), the gNB configures three SRS resources for CSI acquisition (Usage=codebook or M-panel codebook). The UE 1501 can use Panel 1, Panel 2 and Panel 3 to transmit SRS#3, SRS#4, and SRS#, respectively. The gNB can measure SRS#3 to derive TPMI1, measure SRS#4 to derive TPMI2, and measure SRS#5 to derive TPMI3 for Panel 1, Panel 2 and Panel 3, respectively.

Stage 3: DCI Indication

In a first approach of gNB initiative, the gNB can use a DCI grant with two SRIs={0, 1} or one SRI codepoint={2} for the UE 1501 to indicate that Panel#1 and Panel#2 are selected for UL transmission. Moreover, the gNB can use the DCI grant with two TPMIs to indicate the precoders for PUSCHs transmission.

In a second approach of UE initiative, the gNB uses a DCI grant with three TPMIs corresponding to three UE panels. UE selects the best two panels by itself and will follow respective TPMIs to transmit PUSCH and PUCCH with the information of the selected panels and/or TPMIs.

The relation between SRI codepoint and the selected UE panel or TRP can be signaled by UE specific RRC or MAC-CE with multiple options. FIG. 15C shows three such options: Option 1, Option 2, and Option 3. The gNB can use a DCI codepoint to dynamically indicate the PUSCH(s) transmission with a single-TRP (s-TRP) or multi-TRP transmission (m-TRP). For example, codepoint={2} in Option 2 and Option 3 can indicate two TRPs and two UE panels are selected for the transmission. Codepoint={1} in Option 2 and Option 3 can indicate TRP 2 and UE panel 1 in FIG. 15A are selected for the transmission. In FIG. 15C, “CB” denotes “codebook-based transmission”, while “NCB” denotes “non-codebook-based transmission”.

Stage 4: Uplink Transmission

The UE 1501 follows the DCI grant to transmit PUSCH and/or PUCCH using the indicated panels and precoders.

### EXAMPLE 3

### SRS Procedure for Non-Codebook-Based Transmission

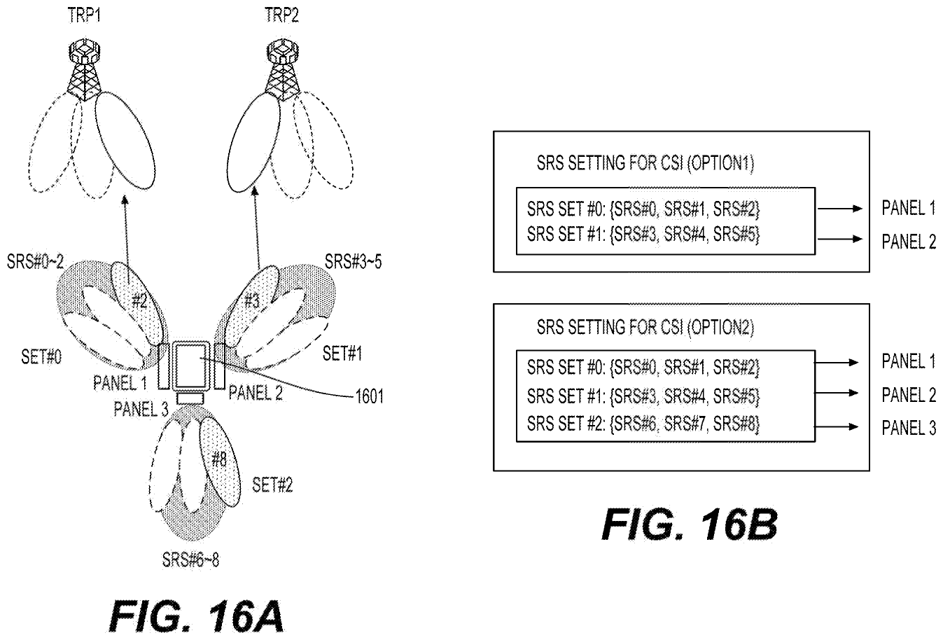

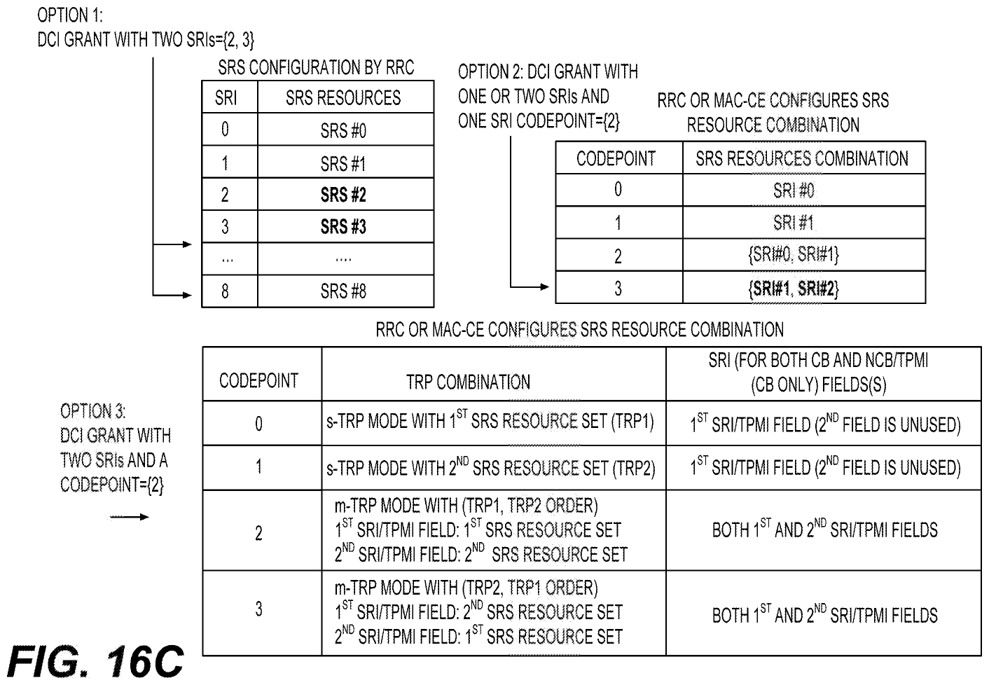

Example 3 is related with an SRS procedure for Non-Codebook-Based Transmission and described with reference to FIGS. 16A-16C. The SRS procedure of Example 3 can include multiple stages. FIG. 16A shows a CSI acquisition stage. FIG. 16B shows SRS resource configurations at the stage of CSI acquisition. FIG. 16C shows options of DCI indication schemes at a stage of DCI indication. As shown in FIGS. 16A, a gNB has two TRPs, “TRP1” and “TRP2”, with six Tx beams and a UE 1601 has three panels.

Stage 1: UE Panel Selection

The panel selection can be decided by the UE 1601 using the panel selection method in Example 1, or decided by the gNB using the panel selection method in Example 2.

Stage: CSI Acquisition

In a first option (Option 1), the gNB selects the best two panels with the highest RSRPs or SINRs in stage 1. As shown in Option 1 of FIG. 16B, the gNB configures two SRS resource sets corresponding to the selected panels for CSI acquisition (Usage=Non-codebook). For each resource set, three SRS resources are configured for UL SRS beam sweep. The UE 1601 can use Panel 1 to transmit SRS#0˜2 and Panel 2 to transmit SRS#3˜5, as shown in FIG. 16A. Each SRS resources can be transmitted to different directions, for example, for beam sweep, or simultaneously. The gNB can measure the SRS#0˜5 to select two SRIs by maximizing capacity metric or SRS-RSRPs for UL transmission.

In a second option (Option), the gNB configures three SRS resource sets corresponding to the three UE panels for CSI acquisition (Usage=Non-codebook), as shown in Option 2 of FIG. 16B. For each resource set, three SRS resources are configured for UL SRS beam sweep or cover multiple directions without beam sweeping. The UE 1601 can use Panel 1 to transmit SRS#0˜2, Panel 2 to transmit SRS#3˜5 and Panel 3 to transmit SRS#6˜8, as shown in FIG. 16A. Each SRS resources can be transmitted to different directions, for example, for beam sweeping, or simultaneously. The gNB can measure the SRS#0˜8 to select two SRIs by maximizing capacity metric or SRS-RSRPs for UL transmission.

Stage 3: DCI Indication

In a first approach of gNB initiative, the gNB uses a DCI grant with two SRIs={2, 3} or one SRI codepoint={3} to indicate to the UE 1601 that Panel#1 and Panel#2 are selected and non-codebook based precoder (or columns of a precoder) associated to SRI#3 and SRI#4 is used for PUSCHs transmission.

In a second UE initiative, the gNB uses a DCI grant with three SRIs={2, 3, 8} corresponding to 3 UE panels. UE selects the best two panels by itself and will follow SRIs to transmit PUSCH and PUCCH with a non-codebook based precoder(s).

The relation between SRI codepoint and the selected UE panel or TRP can be signaled by UE specific RRC or MAC-CE with multiple options. FIG. 16C shows three such options: Option 1, Option 2, and Option 3. The gNB can use a DCI codepoint to dynamically indicate the PUSCH(s) transmission with a single-TRP (s-TRP) or multi-TRP transmission (m-TRP). For example, codepoint={2} in Option 2 and Option 3 can indicate two TRPs and two UE panels are selected for the transmission.

Stage 4: Uplink Transmission

The UE 1501 follows the DCI grant to transmit PUSCH and/or PUCCH using the indicated panels and precoders.

### EXAMPLE 4

### Uplink Transmission Process with Enhanced UL Codebook

Example 4 is related with an uplink transmission process based on enhanced UL codebook schemes as described in the FIG. 11 and FIG. 13 examples. In Example 4, the process can include multiple stages. In Example 4, a UE has three panels. Each panel consists of two antenna ports. The UE is served by a gNB.

Stage 1: UE Panel Selection

The panel selection can be decided by the UE using the panel selection method described in Example 1.

Stage 2: CSI Acquisition

The gNB configures two two-port SRS resources with two spatialRelationInfos or UL TCIs respectively for CSI acquisition (Usage=codebook or M-panel codebook). The two two-port SRS resources can be frequency division multiplexed (FDMed) to avoid cross-slot non-coherency problem. Two options are available for determining precoders for the uplink transmission. The two options corresponding to the two enhanced UL codebook schemes as described in the FIG. 11 and FIG. 13 examples, respectively.

In a first option of the multi-TPMI scheme of FIG. 11, the gNB can estimate the UL channel based on SRS measurement to decide two two-port TPMIs corresponding two panels, and derive the co-phasing and/or amplitude information between the two panels.

In a second option of single-TPMI option, the gNB can estimate the UL channel based on SRS measurement to decide one four-port TPMI for transmission from the two panels.

Stage 3: DCI Indication

The gNB can use a DCI grant with two SRIs={0, 1} or one SRI codepoint={2} for the UE to indicate that Panel#1 and Panel#2, for example, are selected for UL transmission. In the multi-TPMI option, the gNB can use a DCI grant with two TPMIs and cross-panel phase and/or amplitude information to indicate the precoder(s) for a PUSCH transmission. In the single-TPMI option, the gNB can use a DCI grant with a single TPMI to indicate the precoder for PUSCH transmission. A precoder corresponding to the single TPMI is designed with consideration of the cross-panel phase and/or amplitude information. The relation between SRI codepoints and the SRS resources can be signaled by UE specific RRC or MAC-CE.

Stage 4: Uplink Transmission

The UE follows the DCI grant to transmit PUSCH and/or PUCCH.

For the multi-TPMI codebook scheme, the cross-panel phase information can be the relative phases (co-phases or phase differences) among panels. The amplitude (co-amplitudes or phase differences) information can be the relative amplitudes or TPC (Transmission Power Control) commands among panels. The UE can apply the selected TPMI(s), the relative phases, and the relative amplitudes or TPC commands to UL transmission. The DCI grant can include at least two TPC command fields, at least two phase fields, or at least two amplitude fields in an example. In some examples, the DCI grant can include one TPC command field, one phase field, or one amplitude field. The command field, phase field, or amplitude field can each indicate a difference of the respective parameter values of the two selected panels.

In an example, the UE can apply the selected TPMI(s), the relative phases, and the relative amplitudes or TPC commands to UL transmission based on an equation, such as:

$$[ \begin{matrix}( a 1 \times p 1 ) \times WTPMI 1 \\ ( a 2 \times p 2 ) \times WTPMI 2\end{matrix} ] or [ \begin{matrix}WTPMI 1 \\ ( a 2 \times p 2 ) \times WTPMI 2\end{matrix} ] ,$$

where α1=relative amplitude for UE Panel 0
p1=relative phase for UE Panel 0
a2=relative amplitude for UE Panel 1
p2=relative phase for UE Panel 1
WTPMI1=precoder matrix from TPMI0
WTPMI2=precoder matrix from TPMI1

For example, the fields of relative phases and the relative amplitudes can be selected from some candidate values configured by RRC or MAC CE signaling or predefined by NR or LTE standard specifications. For cross-polarized antennas, the relative phases and the relative amplitudes can be different values for different polarizations.

V. Exemplary Devices for Multi-Panel Uplink Transmission

Two exemplary devices, Device A and Device B, are described below.

Device A

A user terminal A can include a controller containing at least one control unit, at least one channel estimator, at least two antenna groups (or panels) each including at least one antenna, at least one receiver, and at least one transmitter. The terminal can be configured to perform UL transmission to a cell or a node of a cellular network. The controller is configured to execute steps of:
receiving a DCI with at least two fields to indicate at least two Transmit Power Control (TPC) commands or at least one field to indicate at least one co-phasing information between the at least two antenna groups; and
following the DCI to transmit UL data or control signals.

In an example of the above user terminal A, the at least two fields to indicate the at least two TPC commands are used for UL power control of the at least two antenna groups and the value of a TPC command is one of −4 dB, −1 dB, 0 dB, 1 dB, 4 dB, and etc. for accumulated or absolute power control.

In another example of the above user terminal A, the user terminal derives the UL transmission timings or the frequency-domain phase compensations of the at least two antenna groups based on the at least one co-phasing information.

In another example of the above user terminal A, the DCI further includes at least two TPMIs or SRIs and the at least two fields to indicate the at least two TPC commands are used for UL power control of the at least two TPMIs or SRIs. The value of a TPC command is one of −4 dB, −1 dB, 0 dB, 1 dB, 4 dB, and etc. for accumulated or absolute power control.

Device B

A user terminal B can include a controller containing at least one control unit, at least one channel estimator, at least two antenna groups (or panels) each including at least one antenna, at least one receiver and transmitter. The terminal can be configured to perform UL transmission. The controller is configured to execute steps of:
receiving a DCI with at least two fields to indicate first at least two TPMIs or SRIs;
selecting at least one TPMI or SRI from the at least two TPM Is or SRIs; and
following the DCI and the selected at least one TPMI or SRI to transmit UL data or control signals.

The user terminal follows the DCI and the selected at least one TPMI or SRI to transmit UL data or control signals. The control signals indicate the selection information of the selected at least one TPMI or SRI.

VI. More Exemplary Processes for Multi-Panel Uplink Transmission

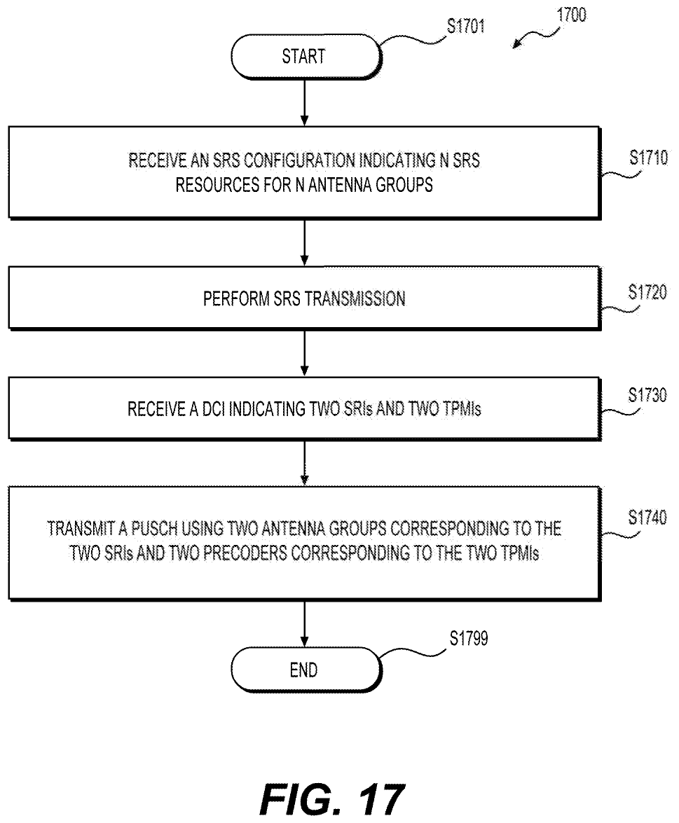

FIG. 17 shows a codebook-based multi-panel uplink transmission process 1700 according to an embodiment of the disclosure. The process can be based on an approach of gNB initiative. The process 1700 can start from SI701 and proceed to S1710.

At S1710, an SRS configuration can be received from a base station (e.g., a gNB) at a UE. The UE can have N antenna groups (or N antenna panels). N can be an integer greater than two, such as 3, 4, or 5. The SRS configuration indicates N SRS resources for the N antenna groups, respectively. The N SRS resources can each be associated with an SRS resource indicator (SRI) (or SRS resource index).

At S1720, an SRS transmission can be performed by the UE. For example, N SRS can be transmitted using the N SRS resources from the N antenna groups, respectively.

At S1730, a DCI can be received from the base station. The DCI schedules a PUSCH. The DCI can indicate two SRIs associated with two of the N SRS resources. The DCI can also indicate two TPMIs.

At S1740, the PUSCH can be transmitted using two antenna groups of the N antenna groups. The two antenna groups can correspond to the two SRIs indicated in the DCI. Also, two precoders corresponding to the two TPMIs indicated in the DCI can be selected from a codebook for the transmission of the PUSCH. The two precoders can be applied to layers of the PUSCH. Output from the two precoders can be input to the corresponding two antenna groups. The process 1700 can proceed to S1799 and terminate at S1799.

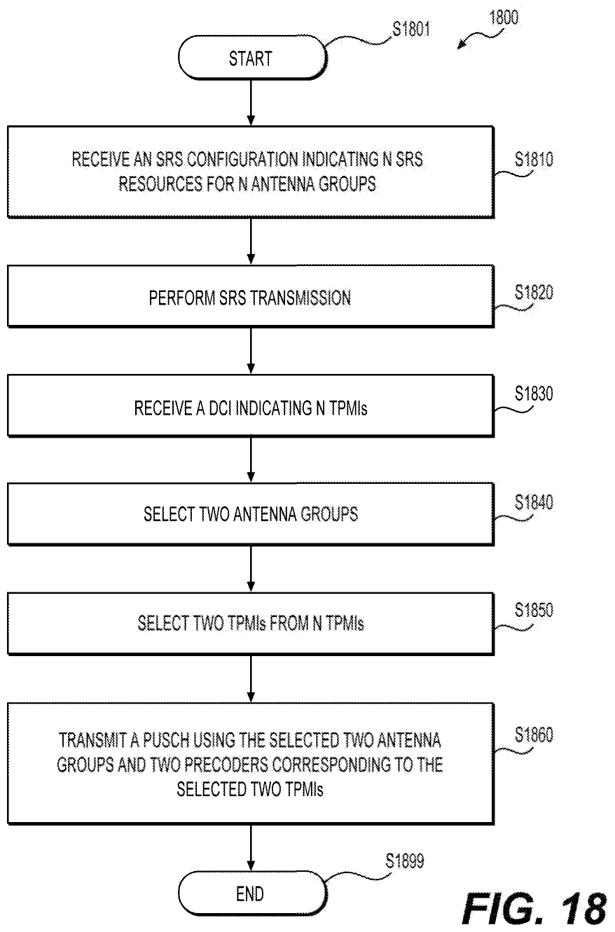

FIG. 18 shows another codebook-based multi-panel uplink transmission process 1800 according to an embodiment of the disclosure. The process 1800 can be based on an approach of UE initiative. The process 1800 can start from S1801 and proceed to S1810.

At S1810, an SRS configuration can be received from a base station at a UE. The UE can have N antenna groups (or N antenna panels). N can be an integer greater than two, such as 3, 4, or 5. The SRS configuration indicates N SRS resources for the N antenna groups, respectively. The N SRS resources can each be associated with an SRS resource indicator (SRI) (or SRS resource index).

At S1820, an SRS transmission can be performed by the UE. For example, N SRS can be transmitted using the N SRS resources from the N antenna groups, respectively.

At S1830, a DCI can be received from the base station. The DCI schedules a PUSCH. The DCI can indicate N TPMIs corresponding to the N antenna groups, respectively.

At S1840, two antenna groups can be selected at the UE from the N antenna groups for transmission of the PUSCH.

At S1850, two TPM Is can be selected from the N TPMIs. The selected two TPMIs correspond to the selected two antenna groups.

At S1860, the PUSCH is transmitted using the selected two antenna groups with two precoders corresponding to the two TPMIs selected from the N TPMIs. The process 1800 can proceed to S1899 and terminate at S1899.

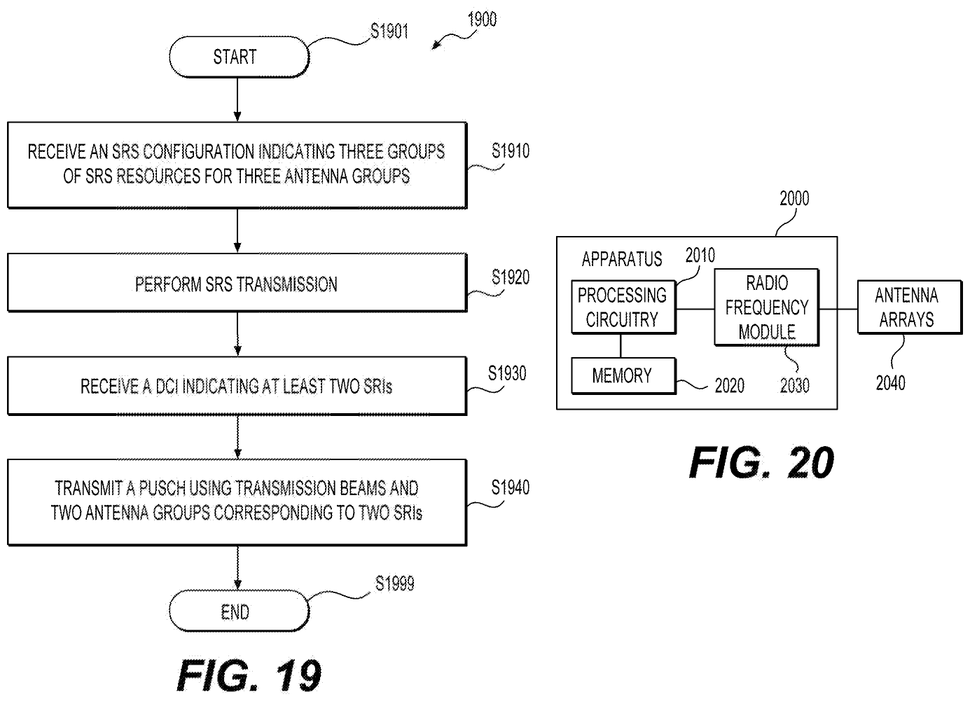

FIG. 19 shows a non-codebook-based multi-panel uplink transmission process 1900 according to an embodiment of the disclosure. The process 1900 can be based on an approach of UE initiative. The process 1900 can start from S1901 and proceed to S1910.

At S1910, an SRS configuration can be received from a base station at a UE. The UE can have three antenna groups. The SRS configuration indicates three groups of SRS resources for the three antenna groups, respectively. Each SRS resource of the three groups of SRS resources is associated with an SRI.

At S1920, performing SRS transmission using the three groups of SRS resources from the three antenna groups, respectively. Each SRS resource of the three groups of SRS resources corresponds to a transmission beam from the respective antenna group.

At S1930, a DCI can be received at the UE. The DCI indicates at least two SRIs of the SRIs associated with each SRS resource of the three groups of SRS resources. The DCI schedules a (PUSCH). The at least two SRIs correspond to at least two antenna groups, respectively.

At S1940, the PUSCH can be transmitted using the transmission beams from two of the at least two antenna groups corresponding to the at least two SRIs. The transmission beams correspond to two of the at least two SRIs. The process 1900 can proceed to S1999 and terminate at S1999.

VII. Exemplary Apparatus

FIG. 20 shows an exemplary apparatus 2000 according to embodiments of the disclosure. The apparatus 2000 can be configured to perform various functions in accordance with one or more embodiments or examples described herein. Thus, the apparatus 2000 can provide means for implementation of mechanisms, techniques, processes, functions, components, systems described herein. For example, the apparatus 2000 can be used to implement functions of UEs or BSs in various embodiments and examples described herein. The apparatus 2000 can include a general purpose processor or specially designed circuits to implement various functions, components, or processes described herein in various embodiments. The apparatus 2000 can include processing circuitry 2010, a memory 2020, and a radio frequency (RF) module 2030.

In various examples, the processing circuitry 2010 can include circuitry configured to perform the functions and processes described herein in combination with software or without software. In various examples, the processing circuitry 2010 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 2010 can be a central processing unit (CPU) configured to execute program instructions to perform various functions and processes described herein. Accordingly, the memory 2020 can be configured to store program instructions. The processing circuitry 2010, when executing the program instructions, can perform the functions and processes. The memory 2020 can further store other programs or data, such as operating systems, application programs, and the like. The memory 2020 can include non-transitory storage media, such as a read only memory (ROM), a random access memory (RAM), a flash memory, a solid state memory, a hard disk drive, an optical disk drive, and the like.

In an embodiment, the RF module 2030 receives a processed data signal from the processing circuitry 2010 and converts the data signal to beamforming wireless signals that are transmitted via antenna arrays 2040, or vice versa. In some examples, the RF module 2030 can include a digital to analog converter (DAC), an analog to digital converter (ADC), a frequency up converter, a frequency down converter, filters and amplifiers for reception and transmission operations. In some examples, the RF module 2030 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 2040 can include one or more antenna arrays organized in multiple antenna panels or antenna groups.

The apparatus 2000 can optionally include other components, such as input and output devices, additional or signal processing circuitry, and the like. Accordingly, the apparatus 2000 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer-readable medium, including magnetic storage medium, optical storage medium, flash medium, and solid-state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving a sounding reference signal (SRS) configuration from a base station at a user equipment (UE), the UE having N antenna groups, N being an integer greater than two, the SRS configuration indicating N SRS resources for the N antenna groups, respectively, the N SRS resources each being associated with an SRS resource indicator (SRI);
performing SRS transmission using the N SRS resources from the N antenna groups, respectively;
receiving a downlink control information (DCI) from the base station, the DCI corresponding to a physical uplink shared channel (PUSCH), the DCI indicating two SRIs associated with two of the N SRS resources, the DCI indicating two transmission precoder matrix indicators (TPMIs); and
transmitting the PUSCH using two antenna groups of the N antenna groups corresponding to the two SRIs indicated in the DCI and two precoders corresponding to the two TPMIs indicated in the DCI.

2. The method of claim 1, wherein the DCI indicates more than two SRIs associated with more than two of the N SRS resources, and
the transmitting includes:
transmitting the PUSCH using the more than two antenna groups of the N antenna groups corresponding to the more than two SRIs indicated in the DCI.

3. The method of claim 1, wherein the DCI further indicates one of
co-phasing information of the two antenna groups, and
amplitude information of the two antenna groups.

4. The method of claim 3, wherein the transmitting the PUSCH includes:
transmitting the PUSCH using the two antenna groups based on uplink transmission timings of the two antenna groups derived from the co-phasing information of the two antenna groups.

5. The method of claim 3, wherein the transmitting the PUSCH includes:
transmitting the PUSCH using the two antenna groups based on frequency-domain phase compensations of the two antenna groups derived from the co-phasing information of the two antenna groups.

6. The method of claim 3, wherein the amplitude information of the two antenna groups is indicated by two transmit power control (TPC) commands indicated in the DCI, the two TPC commands corresponding to the two antenna groups, respectively.

7. The method of claim 1, further comprising:
receiving a group-based beam measurement report configuration;
transmitting a group-based beam measurement report based on the group-based beam measurement report configuration, the group-based beam measurement report being obtained based on measurement of channel-state-information reference signals (CSI-RS) or synchronization signal blocks (SSBs) transmitted from the base station, at least two transmission and reception points (TRPs) of the base station, or at least two TRPs of the base station and another base station; and
receiving two transmission configuration indicator (TCI) states for an uplink transmission of SRS, PUSCH, or physical uplink control channel (PUCCH), the two TCI states indicating two of the CSI-RS or two of the SSBs transmitted from the base station, the at least two TRPs of the base station, or the at last two TRPs of the base station and the other base station.

8. The method of claim 7, wherein the group-based beam measurement report includes:
information of downlink beams corresponding to ones of the CSI-RS or SSBs transmitted from the base station, the at least two TRPs of the base station, or the at last two TRPs of the base station and the other base station, or
information of the antenna groups corresponding to the downlink beams.

9. The method of claim 1, further comprising:
receiving a configuration of three SRS resources for UE antenna panel selection and beam measurement, the three SRS resources corresponding to three antenna groups of the N antenna groups, the three SRS resources being associated with three SRIs;
transmitting SRS using the three SRS resources from the three antenna groups, respectively;
receiving two TCI states indicating two SRIs of the three SRIs associated with the three SRS resources for an uplink transmission of SRS, PUSCH, or PUCCH.

10. A method, comprising:
receiving a sounding reference signal (SRS) configuration from a base station at a user equipment (UE), the UE having N antenna groups, N being an integer greater than two, the SRS configuration indicating N SRS resources for the N antenna groups, respectively, the N SRS resources each associated with an SRS resource indicator (SRI);
performing SRS transmission using the N SRS resources from the N antenna groups, respectively;
receiving a first downlink control information (DCI) from the base station, the first DCI scheduling a physical uplink shared channel (PUSCH), the first DCI indicating N transmission precoder matrix indicators (TPMIs) corresponding to the N antenna groups, respectively;
selecting two antenna groups from the N antenna groups for transmission of the PUSCH;
selecting two TPMIs from the N TPMIs, the selected two TPMIs corresponding to the selected two antenna groups; and
transmitting the PUSCH using the selected two antenna groups with two precoders corresponding to the two TPMIs selected from the N TPMIs indicated in the first DCI.

11. The method of claim 10, further comprising:
transmitting a physical uplink control channel (PUCCH) to indicate the selected two antenna groups by indicating two SRIs corresponding to the two selected antenna groups or the selected two TPMIs corresponding to the two selected antenna groups.

12. The method of claim 10, wherein the N antenna groups include three antenna groups, and the method further comprises:
receiving at least one DCI field indicating:
two candidate antenna groups among the three antenna groups, or
co-phasing information and amplitude information of the respective two candidate antenna groups.

13. The method of claim 12, wherein the transmitting includes:
transmitting the PUSCH using the selected two antenna groups based on uplink transmission timings or frequency-domain phase compensations of the selected two antenna groups derived from the co-phasing information indicated by the at least one DCI field.

14. The method of claim 12, wherein the amplitude information of the respective two candidate antenna groups is indicated by two transmit power control (TPC) commands indicated in the respective DCI, the two TPC commands corresponding to the two candidate antenna groups, respectively.

15. The method of claim 10, further comprising:
receiving a group-based beam measurement report configuration;
transmitting a group-based beam measurement report based on the group-based beam measurement report configuration, the group-based beam measurement report being obtained based on measurement of channel-state-information reference signals (CSI-RS)) or synchronization signal blocks (SSBs) transmitted from the base station, at least two transmission and reception points (TRPs) of the base station, or at least two TRPs of the base station and another base station; and
receiving two transmission configuration indicator (TCI) states indicating two of the CSI-RS or two of the SSBs transmitted from the base station, the at least two TRPs of the base station, or the at last two TRPs of the base station and the other base station for an uplink transmission of SRS, PUSCH, or PUCCH.

16. The method of claim 10, further comprising:
receiving a configuration of three SRS resources for UE antenna panel selection and beam measurement, the three SRS resources corresponding to three antenna groups of the N antenna groups, the three SRS resources being associated with three SRIs;
transmitting SRS using the three SRS resources from the three antenna groups, respectively;
receiving two TO states indicating two SRIs of the three SRIs associated with the three SRS resources for an uplink transmission of SRS, PUSCH, or PUCCH.

17. A method, comprising:
receiving a sounding reference signal (SRS) configuration from a base station at a user equipment (UE), the UE having three antenna groups, the SRS configuration indicating three groups of SRS resources for the three antenna groups, respectively, each SRS resource of the three groups of SRS resources being associated with an SRS resource indicator (SRI);
performing SRS transmission using the three groups of SRS resources from the three antenna groups, respectively, each SRS resource of the three groups of SRS resources corresponding to a transmission beam; and
receiving a downlink control information (DCI) indicating at least two SRIs of the SRIs associated with each SRS resource of the three groups of SRS resources, the DCI scheduling a physical uplink shared channel (PUSCH), the at least two SRIs corresponding to at least two antenna groups, respectively; and
transmitting the PUSCH using the transmission beams from two of the at least two antenna groups corresponding to the at least two SRIs, the transmission beams corresponding to two of the at least two SRIs.

18. The method of claim 17, wherein the at least two SRIs include three SRIs corresponding to the three antenna groups, respectively, and
the method further includes:
selecting two antenna groups from the three antenna groups, the selected two antenna groups corresponding to the two of the at least two antenna groups corresponding to the at least two SRIs; and
transmitting a PUCCH to indicate the selected two antenna groups by indicating the two SRIs corresponding to the selected two antenna groups.

19. The method of claim 17, further comprising:
receiving a group-based beam measurement report configuration;
transmitting a group-based beam measurement report based on the group-based beam measurement report configuration, the group-based beam measurement report being obtained based on measurement of channel-state-information reference signals (CSI-RS) or synchronization signal blocks (SSBs) transmitted from the base station, at least two transmission and reception points (TRPs) of the base station, or at least two TRPs of the base station and another base station; and
receiving two transmission configuration indicator (TCI) states indicating two of the CSI-RS or two of the SSBs transmitted from the base station, the at least two TRPs of the base station, or the at last two TRPs of the base station and the other base station for an uplink transmission of SRS, PUSCH, or PUCCH.

20. The method of claim 17, further comprising:
receiving a configuration of three SRS resources for UE antenna panel selection and beam measurement, the three SRS resources for UE antenna panel selection and beam measurement corresponding to the three antenna groups, the three SRS resources being associated with three SRIs;
transmitting SRS using the three SRS resources for UE antenna panel selection and beam measurement from the three antenna groups, respectively;
receiving two TCI states indicating two SRIs of the three SRIs associated with the three SRS resources for UE antenna panel selection and beam measurement for an uplink transmission of SRS, PUSCH, or PUCCH.
